(19) United States
(12) Patent Application Publication
(10) Pub. No.: US 2005/0179360 A1
(43) Pub. Date: Aug. 18, 2005

(54) Image display device, method of manufacturing image display device, and manufacturing apparatus

(76) Inventors: Hisakazu Okamoto, Tokyo (JP); Tsukasa Ooshima, Tokyo (JP); Akiyoshi Yamada, Tokyo (JP); Takashi Enomoto, Tokyo (JP); Masahiro Yokota, Tokyo (JP); Takashi Nishimura, Tokyo (JP); Hirotaka Unno, Tokyo (JP); Hiroharu Takezawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/035,322

(22) Filed: Jan. 14, 2005

Related U.S. Application Data
(63) Continuation of application No. PCT/JP03/08929, filed on Jul. 14, 2003.

(30) Foreign Application Priority Data
Jul. 15, 2002 (JP) 2002-206176
Aug. 22, 2002 (JP) 2002-242044
Sep. 11, 2002 (JP) 2002-265757
Jan. 10, 2003 (JP) 2003-004410
Jan. 21, 2003 (JP) 2003-012199
Feb. 3, 2003 (JP) 2003-026227
May 20, 2003 (JP) 2003-141994
Jun. 5, 2003 (JP) 2003-161034

(51) Int. Cl. H01J 1/62; H01J 63/04

(52) U.S. Cl. 313/495; 313/238; 313/496; 445/25; 445/24

(57) ABSTRACT

An envelope of an image display device has a front substrate and a rear substrate opposed to the front substrate, and respective peripheral edge portions of the front substrate and the rear substrate are sealed together with a sealing layer which contains an electrically conductive sealing material. An electrode for energizing the sealing layer is attached to the envelope. The electrode is formed of an electrically conductive member, is in electrical contact with the sealing layer, and has a conduction portion exposed to the outside.

### CROSS-REFERENCE TO RELATED APPLICATIONS

This is a Continuation Application of PCT Application No. PCT/JP03/08929, filed Jul. 14, 2003, which was not published under PCT Article 21(2) in English.

This application is based upon and claims the benefit of priority from prior Japanese Patent Applications No. 2002-206176, filed Jul. 15, 2002; No. 2002-242044, filed Aug. 22, 2002; No. 2002-265757, filed Sep. 11, 2002; No. 2003-004410, filed Jan. 10, 2003; No. 2003-012199, filed Jan. 21, 2003; No. 2003-026227, filed Feb. 3, 2003; No. 2003-141994, filed May 20, 2003; and No. 2003-161034, filed Jun. 5, 2003, the entire contents of all of which are incorporated herein by reference.

### BACKGROUND OF THE INVENTION

1. Field of the Invention

This invention relates to a flat image display device having substrates opposed to each other, a method of manufacturing the image display device, and a manufacturing apparatus for the image display device.

2. Description of the Related Art

In recent years, various image display devices have been developed as a next generation of lightweight, thin display devices to replace cathode-ray tubes (hereinafter referred to as CRTs). These image display devices include a liquid crystal display (hereinafter referred to as an LCD), plasma display panel (hereinafter referred to as a PDP), field emission display (hereinafter referred to as an FED), surface-conduction electron emission display (hereinafter referred to as an SED), etc. In the LCD, the intensity of light is controlled by utilizing the orientation of a liquid crystal. In the PDP, phosphors are caused to glow by ultraviolet rays that are produced by plasma discharge. In the FED, phosphors are caused to glow by electron beams from fiel-demission electron emitting elements. In the SED, phosphors are caused to glow by electron beams from surface-conduction electron emitting elements.

For example, the FED or SED generally has a front substrate and a rear substrate that are opposed to each other across a predetermined gap. These substrates have their respective peripheral portions joined together by a sidewall in the form of a rectangular frame, thereby constituting a vacuum envelope. A phosphor screen is formed on the inner surface of the front substrate, and a large number of electron emitting elements for use as electron emitting sources that excite the phosphors to luminescence are provided on the inner surface of the rear substrate.

A plurality of support members are arranged between the rear substrate and the front substrate in order to support atmospheric load that acts on these substrates. The potential on the rear substrate side is substantially ground potential, and an anode voltage Va is applied to a phosphor surface. Electron beams emitted from emitters are applied to red, green, and blue phosphors that constitute the phosphor screen, whereby the phosphors are caused to glow and display an image.

According to the FED or SED of this type, the thickness of the display device can be reduced to several millimeters. When compared with a CRT that is used as a display of an existing TV or computer, therefore, they can be made lighter in weight and thinner.

In the FED or SED described above, the inside of the envelope must be kept at high vacuum. Also in the PDP, the envelope must be filled with electric discharge gas after it is internally evacuated once. A method of manufacturing an FED having a vacuum envelope is described in Jpn. Pat. Appln. KOKAI Publication No. 2000-229825 or 2001-210258, for example. According to this method, a front substrate and a rear substrate that constitute the envelope are finally assembled in a vacuum chamber.

In this method, the front substrate and the rear substrate that are carried into the vacuum chamber are fully heated in advance. This is done in order to reduce gas release from the inner wall of the envelope that is the primary cause of lowering of the degree of vacuum of the envelope. When the front substrate and the rear substrate are then cooled so that the degree of vacuum in the vacuum chamber is fully raised, a getter film for improving and maintaining the degree of vacuum of the envelope is formed on a phosphor screen. Thereafter, the front substrate and the rear substrate are heated again to a temperature such that a sealing material melts. The front substrate and the rear substrate are combined in a predetermined position as they are cooled so that the sealing material solidifies.

In the vacuum envelope fabricated by this method, which combines a sealing process and a vacuum encapsulation process, exhaust never requires much time, and a very high degree of vacuum can be obtained. Preferably, moreover, the sealing material used should be a low-melting metallic material that is suited for batch processing for sealing and encapsulation.

If the assembly is carried out in a vacuum in this manner, however, operations to be carried out in the sealing process are diverse, including heating, positioning, and cooling. Further, the front substrate and the rear substrate must be held in the predetermined position for a long time during which the sealing material melts and solidifies. Furthermore, heating or cooling in the sealing process causes the front substrate and the rear substrate to expand thermally, thereby easily lowering the positioning accuracy. Thus, the sealing involves problems in productivity and properties.

As a method to solve these problems, a method is studied in which an electrically conductive sealing material, such as indium, is energized and the resulting Joule heat is utilized to heat and melt the electrically conductive sealing material itself, whereby substrates are coupled together (hereinafter referred to as electrical heating). According to this method, an envelope can be vacuum-sealed in a short time by a simple apparatus without consuming much time for substrate cooling. Thus, with use of the electrically conductive sealing material, only the sealing material that has a small heat capacity can be selectively heated without heating the substrates, so that lowering of the positional accuracy that is attributable to thermal expansion of the substrates can be restrained. Since the heat capacity of the sealing material is much smaller than the heat capacity of the substrates, moreover, the heating and cooling times can be made much shorter than in the case of a method in which the substrates are heated entirely, so that the mass-productivity can be improved considerably.

In the case of the electrical heating, however, steady current must be supplied to the electrically conductive sealing material. If the current value is not stable, however, the time for meting the electrically conductive sealing material varies depending on each individual envelope, so that the substrates cannot be steadily coupled together. If the electrically conductive sealing material is excessively heated, the substrates are cracked by the resulting heat. If the material is not fully melted, in contrast with this, the substrates cannot be coupled satisfactorily, so that a problem arises that the vacuum of the envelope cannot be maintained afterward in an exhaust process, for example.

### BRIEF SUMMARY OF THE INVENTION

This invention has been made in consideration of these circumstances, and its object is to provide an image display device, a method of manufacturing the image display device, and a manufacturing apparatus, which ensure quick and steady sealing operation.

According to an aspect of the invention, there is provided an image display device comprising: an envelope having a front substrate and a rear substrate opposed to the front substrate, respective peripheral edge portions of the front substrate and the rear substrate being sealed together with a sealing layer which contains an electrically conductive sealing material; and an electrode member which is attached to the envelope to be in electrical contact with the sealing layer and serves to energize the sealing layer.

According to another aspect of the invention, there is provided a method of manufacturing an image display device which is provided with an envelope having a front substrate and a rear substrate opposed to each other and having respective peripheral portions thereof joined together, the method comprising: locating an electrically conductive sealing material on the peripheral edge portion of at least one of the front and rear substrates, thereby forming a sealing layer; attaching an electrode member to the at least one of the front and rear substrates having the sealing layer formed thereon, and connecting the electrode member electrically to the sealing layer; and energizing the sealing layer through the electrode member with the front substrate and the rear substrate opposed to each other, thereby heat-melting the sealing layer to join together the respective peripheral portions of the front substrate and the rear substrate.

According to the image display device and the manufacturing method arranged in this manner, the electrode is connected electrically to the sealing layer that is previously attached to the envelope, and the envelope is formed by electrically heating the sealing layer through the electrode. Thus, a steady current can be supplied to the sealing layer that is formed of the electrically conductive sealing material, and sealing operation for the image display device can be speeded up and stabilized.

### BRIEF DESCRIPTION OF THE SEVERAL VIEWS OF THE DRAWING

FIG. 1 is a perspective view showing an outline of an FED according to a first embodiment of this invention;

FIG. 2 is a perspective view showing an internal configuration of the FED;

FIG. 3 is a sectional view taken along line III-III of FIG. 1;

FIG. 4 is a plan view enlargedly showing a part of a phosphor screen of the FED;

FIG. 5 is a perspective view showing an electrode of the FED;

FIGS. 6A and 6B are plan views showing a front substrate and a rear substrate, respectively, used in the manufacture of the FED;

FIG. 7 is a perspective view showing a state in which electrodes are attached to the rear substrate of the FED;

FIG. 8 is a sectional view showing a state in which the rear substrate and the front substrate are opposed to each other with indium located on the seal portion;

FIG. 9 is a diagram schematically showing a vacuum processor used in the manufacture of the FED;

FIG. 10 is a plan view typically showing a state in which a power source is connected to the electrodes on the FED in a manufacturing process for the FED;

FIG. 11 is a perspective view showing a part of an FED according to a second embodiment of this invention;

FIGS. 12A and 12B are sectional views showing manufacturing processes for the FED according to the second embodiment;

FIG. 13 is a plan view typically showing a state in which the power source is connected to electrodes of an FED according to a third embodiment of this invention in a manufacturing process for the FED;

FIGS. 14A and 14B are sectional views showing manufacturing processes for the FED according to the third embodiment;

FIG. 15 is a perspective view showing an outline of an FED according to a fourth embodiment of this invention;

FIG. 16 is a sectional view taken along line XVI-XVI of FIG. 15;

FIG. 17 is a perspective view showing an electrode of the FED;

FIGS. 18A and 18B are plan views showing a front substrate and a rear substrate, respectively, used in the manufacture of the FED;

FIG. 19 is a sectional view showing a state in which the rear substrate and the front substrate are opposed to each other with indium located thereon;

FIG. 20 is a sectional view showing a modification of the electrode according to the fourth embodiment;

FIG. 21 is a perspective view showing another modification of the electrode of the fourth embodiment;

FIG. 22 is a sectional view showing the another modification of the fourth embodiment;

FIG. 23 is a perspective view showing an outline of an FED according to a fifth embodiment of this invention;

FIG. 24 is a sectional view taken along line XXIV-XXIV of FIG. 15;

FIG. 25 is a perspective view showing an electrode of the FED according to the fifth embodiment;

FIG. 26 is a sectional view showing an electrode according to a modification of the fifth embodiment;

FIG. 27 is a perspective view showing an electrode according to another modification of the fifth embodiment;

FIG. 28 is a sectional view showing the electrode according to the another modification of the fifth embodiment;

FIG. 29 is a perspective view showing an electrode according to still another modification of the fifth embodiment;

FIG. 30 is a perspective view showing an FED according to a sixth embodiment of this invention;

FIG. 31A is a plan view showing a front substrate used in the manufacture of the FED;

FIG. 31B is a plan view showing a rear substrate, sidewall, and spacers used in the manufacture of the FED;

FIG. 32 is a sectional view showing a sealing process for the front substrate and the sidewall in a manufacturing method according to the sixth embodiment;

FIG. 33 is a plan view showing electrodes of a modification of the sixth embodiment;

FIGS. 34A and 34B are plan views individually showing alternative modifications of the electrode of the sixth embodiment;

FIG. 35 is a sectional view illustrating a manufacturing method for an FED according to a seventh embodiment of this invention;

FIG. 36 is a sectional view showing a sealing process using electrodes according to a modification of the seventh embodiment;

FIG. 37 is a sectional view illustrating a manufacturing method for an FED according to an eighth embodiment of this invention;

FIG. 38 is a sectional view showing a state in which electrodes are inserted between substrates in the eighth embodiment;

FIG. 39 is a sectional view showing a state in which the two substrates are pressurized toward each other in the eighth embodiment;

FIG. 40 is a sectional view illustrating a manufacturing method for an FED according to a ninth embodiment of this invention;

FIG. 41 is a sectional view showing a state in which an electrode is in contact with a welded portion of a sealing layer in the ninth embodiment;

FIG. 42 is a perspective view showing an outline of an FED according to a tenth embodiment of this invention;

FIG. 43 is a sectional view taken along line XLIII-XLIII of FIG. 42;

FIG. 44 is a perspective view showing an electrode of the FED according to the tenth embodiment;

FIG. 45 is a perspective view showing a state in which electrodes are attached to a rear substrate in the tenth embodiment;

FIG. 46 is a sectional view showing a state in which the rear substrate and a front substrate are opposed to each other with sealing layers thereon in the tenth embodiment;

FIG. 47 is a sectional view showing a state in which the rear substrate and the front substrate are pressurized toward each other so that a contact portion of the electrode is sandwiched between the sealing layers in the tenth embodiment;

FIG. 48 is a perspective view showing an electrode according to a modification of the tenth embodiment;

FIG. 49 is a perspective view showing an electrode according to another modification of the tenth embodiment;

FIG. 50 is a perspective view showing an electrode according to still another modification of the tenth embodiment;

FIG. 51 is a sectional view showing the electrode according to the another modification of the tenth embodiment;

FIG. 52 is a sectional view showing a state in which the rear substrate and the front substrate are opposed to each other with indium located thereon in a modification of the tenth embodiment;

FIG. 53 is a sectional view showing a state in which the rear substrate and the front substrate are opposed to each other with indium located thereon in another modification of the tenth embodiment;

FIG. 54 is a sectional view showing an electrode according to a modification of the tenth embodiment;

FIG. 55 is a sectional view showing a process for removing an electrode according to an eleventh embodiment of this invention;

FIG. 56 is a sectional view showing a process for removing the electrode in the eleventh embodiment;

FIG. 57 is a perspective view showing an FED of the eleventh embodiment with its electrode removed;

FIG. 58 is a sectional view showing the FED of the eleventh embodiment with its electrode removed;

FIG. 59 is a sectional view showing a process for removing an electrode of a modification of the eleventh embodiment;

FIG. 60 is a sectional view showing a process for removing an electrode of another modification of the eleventh embodiment;

FIGS. 61A to 61E are plan views individually showing modifications of recesses in a sealing layer of the FED of the eleventh embodiment;

FIG. 62 is a sectional view showing a process for cutting an electrode according to a twelfth embodiment of this invention;

FIG. 63 is a sectional view showing a process for removing the cut electrode of the twelfth embodiment;

FIG. 64 is a sectional view showing an FED according to a thirteenth embodiment of this invention;

FIG. 65 is a perspective view showing a state in which electrodes are attached to a rear substrate in the tenth embodiment;

FIG. 66 is a sectional view showing a manufacturing apparatus according to the thirteenth embodiment;

FIG. 67 is a perspective view schematically showing the manufacturing apparatus; and

FIG. 68 is a sectional view showing a manufacturing apparatus according to a modification of the thirteenth embodiment.

### DETAILED DESCRIPTION OF THE INVENTION

An FED according to a first embodiment of this invention and its manufacturing method will now be described in detail with reference to the drawings.

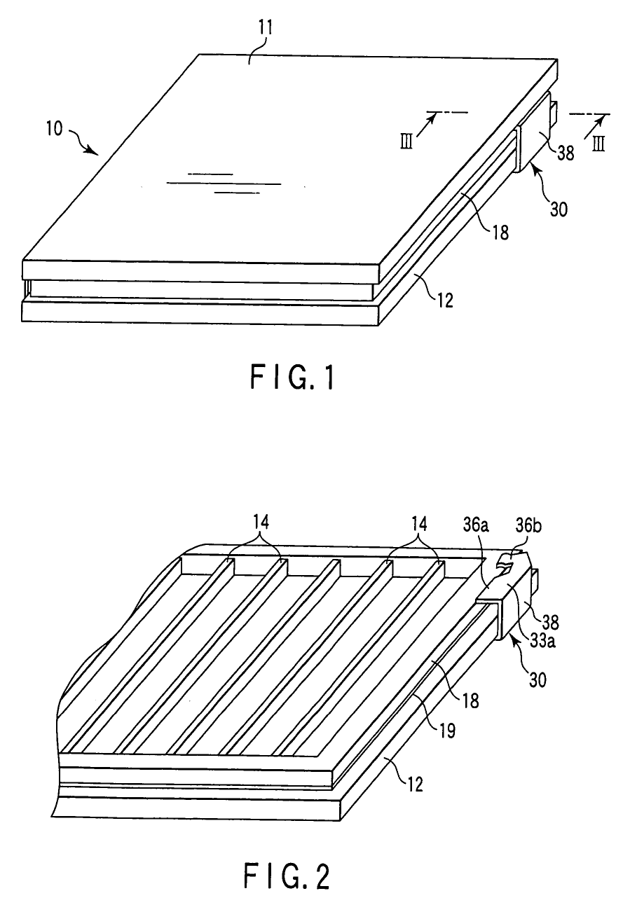

As shown in FIGS. 1 to 4, the FED comprises a front substrate 11 and a rear substrate 12, which are formed of a rectangular glass sheet each. These substrates are opposed to each other across a gap of about 1 to 2 mm. The front substrate 11 and the rear substrate 12 have their respective peripheral edge portions joined together by a sidewall 18 in the form of a rectangular frame, and constitute a flat, rectangular vacuum envelope 10 that is kept in a vacuum inside.

A plurality of sheetlike support members 14 are arranged in the vacuum envelope 10 in order to support atmospheric load that acts on the front substrate 11 and the rear substrate 12. These support members 14 individually extend parallel to one side of the vacuum envelope 10 and are arranged at given spaces along a direction perpendicular to the one side. The support members 14 are not limited to the sheetlike shape, and columnar ones may be used instead.

A phosphor screen 16 that functions as an image display surface is formed on the inner surface of the front substrate 11. The phosphor screen 16 is formed by arranging red, green, and blue phosphor layers R, G and B and a light absorbing layer 20 situated between these phosphor layers. The phosphor layers R, G and B extend parallel to the one side of the vacuum envelope and are arranged at given spaces along a direction perpendicular to the one side. The light absorbing layer 20 is located around the phosphor layers R, G and B. A metal back 17 of, e.g., aluminum and a getter film 13 are successively vapor-deposited on the phosphor screen 16.

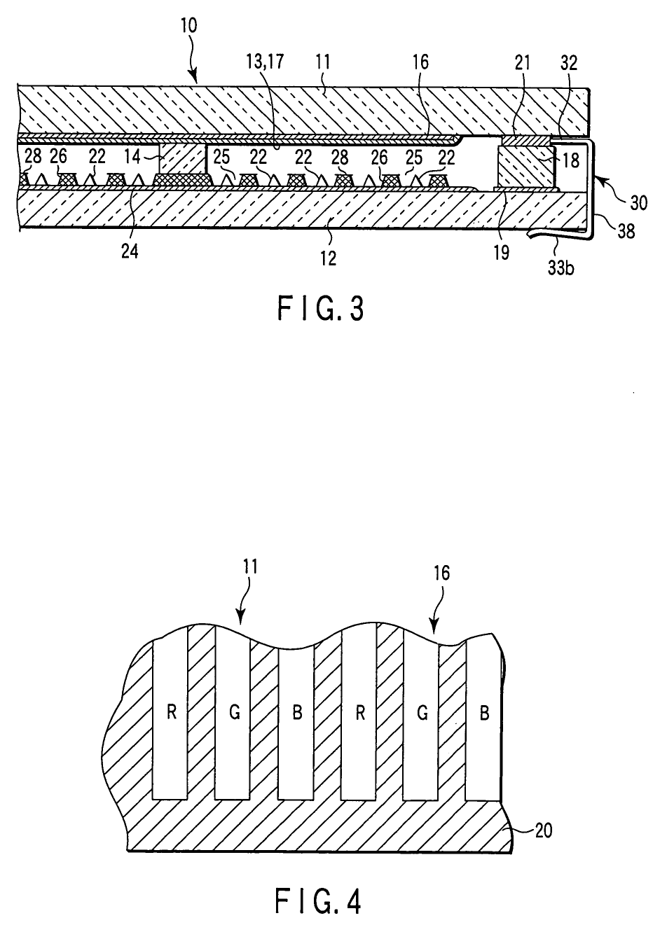

As shown in FIG. 3, a large number of electron emitting elements 22 are arranged on the inner surface of the rear substrate 12. They serve as electron emitting sources that excite the phosphor layers of the phosphor screen 16. These electron emitting elements 22 are arranged in a plurality of columns and a plurality of rows corresponding to individual pixels. More specifically, an electrically conductive cathode layer 24 is formed on the inner surface of the rear substrate 12, and a silicon dioxide film 26 having a large number of cavities 25 are formed on the electrically conductive cathode layer. Gate electrodes 28 of molybdenum, niobium or the like are formed on the silicon dioxide film 26. On the inner surface of the rear substrate 12, the cone-shaped electron emitting elements 22 of molybdenum or the like are provided in the cavities 25, individually.

In the FED constructed in this manner, video signals are applied to the electron emitting elements 22 and the gate electrodes 28 that are formed in a simple matrix. A gate voltage of +100V is applied to the electron emitting elements 22 as a reference when in a highest-luminance state. Further, +10 kV is applied to the phosphor screen 16. Thereupon, electron beams are emitted from the electron emitting elements 22. The electron beams emitted from the electron emitting elements 22 are modulated in size by the voltage of the gate electrodes 28. These electron beams excite the phosphor layers of the phosphor screen 16 to luminescence, thereby displaying an image.

Since the high voltage is applied to the phosphor screen 16, high-strain glass is used as a sheet glass for the front substrate 11, rear substrate 12, sidewall 18, and support members 14. As described later, the space between the rear substrate 12 and the sidewall 18 is sealed with low-melting glass 19, such as fritted glass. The space between the front substrate 11 and the sidewall 18 is sealed with a sealing layer 21 that contains indium (In) as an electrically conductive low-melting sealing material.

The FED is provided with a plurality of, e.g., a pair of, electrodes 30, and these electrodes are attached to the envelope 10 in a manner such that they conduct electrically to the sealing layer 21. These electrodes 30 are used as electrode members for energizing the sealing layer 21.

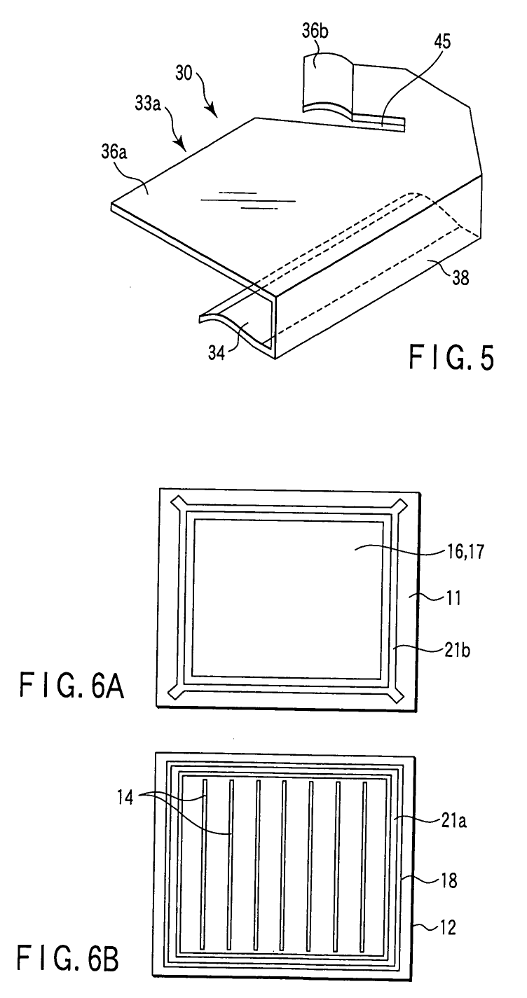

As shown in FIG. 5, each electrode 30 is formed in the shape of a clip by working, for example, a copper sheet of 0.2-mm thickness as an electrically conductive member. More specifically, the electrode 30 is bent to have a substantially U-shaped profile. It includes a flat first sheet portion 33a, a second sheet portion 33b opposed to the first sheet portion across a gap, and a conduction portion 38 that extends substantially at right angles to the first and second sheet portions and connects respective end edge portions of the first and second sheet portions. The first sheet portion 33ba has first and second contact portions 36a and 36b that individually conduct to the sealing layer 21. A slit 45 is formed between the first and second contact portions 36a and 36b. The second contact portion 36b is in the form of a claw and can be easily elastically deformed.

As shown in FIGS. 1 to 3, each electrode 30 is attached to the vacuum envelope 10 in a manner such that it elastically engages, for example, the rear substrate 12 and the sidewall 18. Thus, the electrode 30 is fixed to the vacuum envelope 10 with the end edge portion of the rear substrate 12 and the sidewall 18 elastically held between the first sheet portion 33ba and the second sheet portion 33b. The first and second contact portions 36a and 36b of the first sheet portion 33a individually touch and conduct electrically to the sealing layer 21. Further, the conduction portion 38 of each electrode 30 is opposed to a side face of the rear substrate 12 and the sidewall 18 and exposed to the outside of the vacuum envelope 10. These paired electrodes 30 are provided individually at two diagonally spaced corner portions of the vacuum envelope 10 and located symmetrically with respect to the sealing layer 21.

The following is a detailed description of the manufacturing method for the FED having the configuration described above.

First, the phosphor screen 16 is formed on the sheet glass for the front substrate 11. In this case, a sheet glass as large as the front substrate 11 is prepared, and a phosphor stripe pattern is formed in advance on the sheet glass using a plotter machine. The sheet glass having this phosphor stripe pattern thereon and the sheet glass for the front substrate are placed on a positioning jig and set on an exposure stage. By exposing and developing the phosphor stripe pattern in this state, the phosphor screen is formed on the glass sheet for the front substrate 11. Thereafter, the metal back 17 is formed overlapping the phosphor screen 16.

Subsequently, the electron emitting elements 22 are formed on the sheet glass for the rear substrate 12. In doing this, the electrically conductive cathode layer 24 in the shape of a matrix is formed on the sheet glass, and an insulating film of silicon dioxide is formed on the cathode layer by, for example, the thermal oxidation method, CVD method, or sputtering method. Thereafter, a metal film of molybdenum or niobium for gate electrode formation is formed on the insulating film by, for example, the sputtering method or electron beam vapor deposition method. Then, a resist pattern of a shape corresponding to the gate electrodes to be formed is formed on this metal film by lithography. The gate electrodes 28 are formed by etching the metal film by the wet etching method or dry etching method using the resist pattern as a mask.

Thereafter, the cavities 25 are formed by etching the insulating film by the wet etching method or dry etching method using the resist pattern and the gate electrodes 28 as masks. After the resist pattern is removed, electron beams for vapor deposition are applied to the surface of the rear substrate 12 in a direction at a given angle thereto, whereupon separation layers of, e.g., aluminum or nickel are formed on the gate electrodes 28. Thereafter, molybdenum as an example of a material for cathode formation is vapor-deposited on the surface of the rear substrate at right angles to it by the electron beam vapor deposition method. Thereupon, the electron emitting elements 22 are formed individually in the cavities 25. Then, the separation layer is removed together with the metal film thereon by the lift-off method. Subsequently, the sidewall 18 and the support members 14 are sealed onto the inner surface of the rear substrate 12 with the low-melting glass 19 in the atmosphere.

Thereafter, a sealing layer 21a is formed by spreading indium to a given width and thickness over the entire periphery of a seal surface of the sidewall 18, as shown in FIGS. 6A and 6B. Likewise, a sealing layer 21b is formed by spreading indium in the shape of a rectangular frame with a given width and thickness over a seal surface of the front substrate 11 that faces the sidewall. As mentioned before, the sealing layers 21a and 21b are loaded onto the respective seal surfaces of the sidewall 18 and the front substrate 11 by a method in which melted indium is applied to the seal surfaces or a method such that solid indium is placed on the seal surfaces.

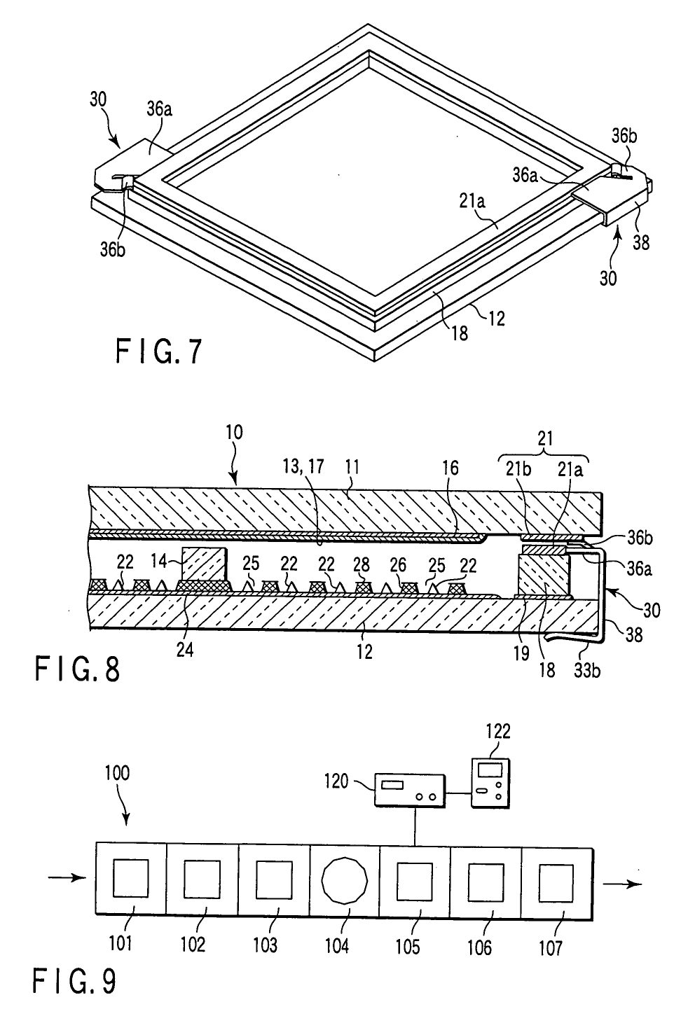

Subsequently, the paired electrodes 30 are mounted on the rear substrate 12 to which the sidewall 18 is joined, as shown in FIG. 7. As this is done, the first contact portion 36a of each electrode 30 is brought into contact with the sealing layer 21a on the sidewall 18, whereby the electrode is connected electrically to the sealing layer. In order to secure electrical conduction between the first contact portion 36a and the sealing layer, it is effective to solder together the sealing layer 21a and the first contact portion 36a in advance. The electrodes 30 are expected to be a pair of electrodes, positive and negative, on the substrate, and lengths for conduction from the individual electrodes to the sealing layers 21a and 21b should preferably be made equal. To attain this, the paired electrodes 30 are attached individually to the two corner portions that face each other in the diagonal direction of the rear substrate 12, and the respective lengths of the sealing layers 21a and 21b that are situated between the electrodes are set to be substantially equal on the opposite sides of each electrode.

After the electrodes 30 are mounted, the rear substrate 12 and the front substrate 11 are opposed to each other at a given space, and in this state, put into a vacuum processor. In this case, a vacuum processor 100 shown in FIG. 9 is used, for example. The vacuum processor 100 comprises a loading chamber 101, baking/electron beam cleaning chamber 102, cooling chamber 103, vapor deposition chamber 104 for getter film, assembly chamber 105, cooling chamber 106, and unloading chamber 107, which are arranged side by side.

The assembly chamber 105 is connected with a DC power source 120 for energization and a computer 122 for controlling the power source. Each chamber of the vacuum processor 100 is constructed as processing chamber capable of vacuum processing, and all the chambers are evacuated during the manufacture of the FED. These processing chambers are connected by gate valves (not shown) and the like.

The front substrate 11 and the rear substrate 12 that are spaced from each other are first put into the loading chamber 101. After the loading chamber 101 is evacuated, the substrates are fed into the baking/electron beam cleaning chamber 102.

In the baking/electron beam cleaning chamber 102, the individual members are heated to a temperature of 300° C., and a gas that is adsorbed on the respective surfaces of the substrates and the sidewall is discharged. At the same time, electron beams emitted from an electron beam generator (not shown) in the baking/electron beam cleaning chamber 102 are applied to a phosphor screen surface of the front substrate 11 and electron emitting element surfaces of the rear substrate 12. In doing this, the electron beams are deflected for scanning by a deflector that is attached to the outside of the electron beam generator, whereby the phosphor screen surface and the electron emitting element surfaces are individually entirely cleaned with the electron beams.

Then, the front substrate 11 and the rear substrate 12, thus subjected to the heating and electron beam cleaning, are fed into the cooling chamber 103 and cooled to a temperature of about 120° C., and then delivered to the vapor deposition chamber 104 for getter film. In the vapor deposition chamber 104, a Ba film is vapor-deposited as a getter film on the outside of the phosphor layers. The surface of the Ba film is prevented from being contaminated by oxygen, carbon, etc., so that it can maintain its active state.

Subsequently, the front substrate 11 and the rear substrate 12 are fed into the assembly chamber 105. In this assembly chamber 105, as shown in FIG. 8, the front substrate 11 and the rear substrate 12 are kept at about 120° C. as they are moved toward each other, and the second contact portion 36b of each electrode 30 is brought into contact with the sealing layer 21b on the side of the front substrate 11. Thereupon, the electrodes 30 are connected electrically to the sealing layer 21b. As this is done, the second contact portion 36b is elastically pressed against the sealing layer 21b under a spring pressure, so that stable electrical conductivity can be ensured.

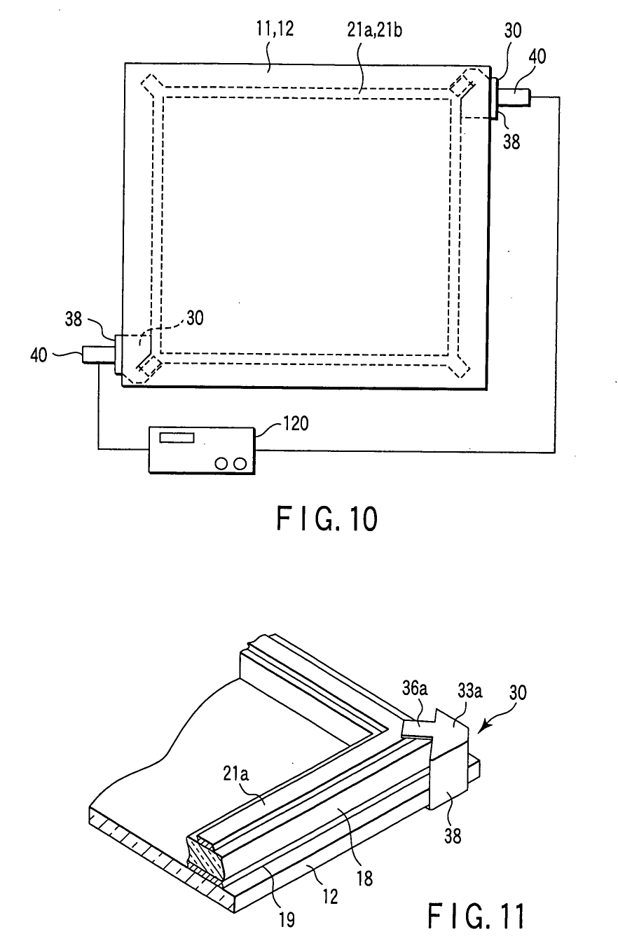

After the power source 120 is then connected electrically to the pair of electrodes 30, as shown in FIG. 10, the sealing layer 21a on the side of the sidewall 18 and the sealing layer 21b on the side of the front substrate 11 are individually energized to be heated, thereby melting the indium. In doing this, connector terminals 40 that are connected to the power source 120 are brought individually into contact with the conduction portions 38 of the electrodes 30, whereby electrical conduction can be secured between the electrodes and between the electrodes and the sealing layers 21a and 21b.

After the indium is melted, the front substrate 11 and the rear substrate 12 are pressurized in a direction such that they approach each other. Thereupon, the sealing layers 21a and 21b are fused together to form the sealing layer 21, and the peripheral edge portion of the front substrate 11 and the sidewall 18 are sealed together with the resulting sealing layer. The vacuum envelope 10, formed in the processes described above, is cooled to normal temperature in the cooling chamber 106 and taken out of the unloading chamber 107. Thus, the vacuum envelope of the FED is completed.

If necessary, the electrodes 30 may be cut off after the vacuum envelope is completed.

According to the FED constructed in this manner and its manufacturing method, the electrodes 30 for the energization of the sealing layer 21 are previously attached to the envelope and fixed so that they are connected electrically to the sealing layer. During electrical heating, therefore, steady current can be supplied through the electrodes 30 to the sealing layer 21. During sealing operation, therefore, the electrically conductive low-melting sealing material that forms the sealing layer can be melted stably and securely in a predetermined energization time. In consequence, quick and secure sealing can be carried out without causing the sealing layer 21 to crack, for example.

Since the front substrate and the rear substrate are sealed and joined together in a vacuum atmosphere, the surface-adsorbed gas can be satisfactorily discharged by combining baking and electron beam cleaning, and a getter film with excellent adsorption capacity can be obtained. Since the front substrate and the rear substrate are sealed and joined together by electrically heating the indium, moreover, they need not be entirely heated, and deterioration of the getter film, cracking of the substrates during the sealing process, or other failure can be avoided. At the same time, the sealing time can be shortened.

Thus, the FED can be obtained at low cost that enjoys excellent productivity and ensures acquisition of stable, satisfactory images.

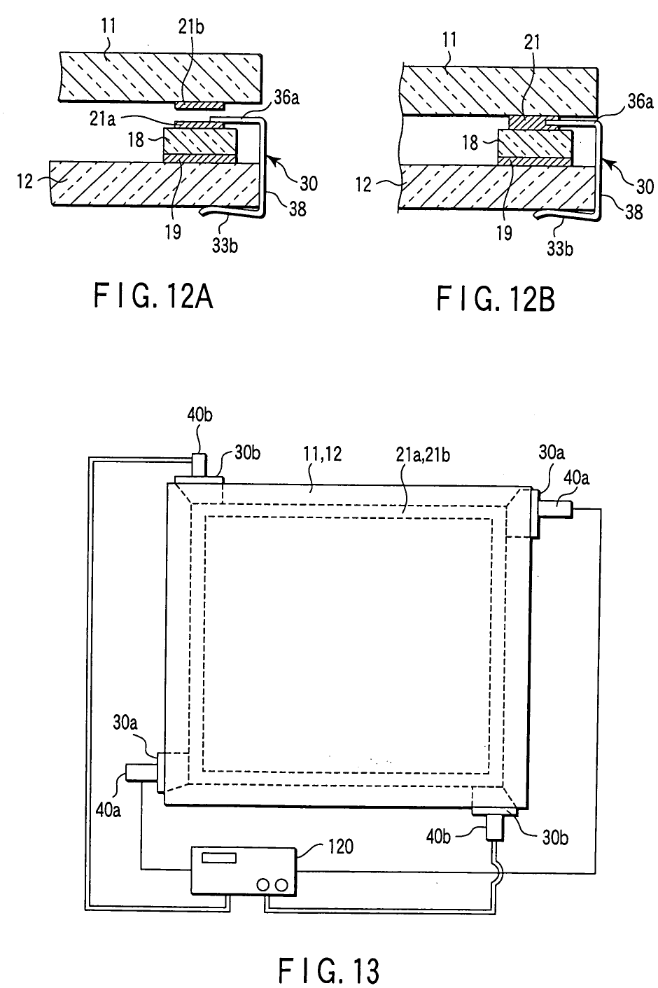

The following is a description of an FED according to a second embodiment of this invention. In the foregoing embodiment, each electrode is constructed having the first contact portion that conducts to the sidewall-side sealing layer and the second contact portion that conducts to the front-substrate-side sealing layer. According to the second embodiment, however, an electrode 30 is formed having a single contact portion 36a, as shown in FIGS. 11, 12A and 12B. A pair of electrodes 30 are attached individually to a pair of corner portions of a rear substrate 12 that are opposed to each other in the diagonal direction of the rear substrate. They are mounted on an envelope in a manner such that they elastically hold a sidewall 18 and the rear substrate 12 between them. In this case, each contact portion 36a is in contact with the upper surface of a sealing layer 21a and connected electrically to the sealing layer.

In the sealing process, a front substrate 11 having a sealing layer 21b thereon is opposed to the rear substrate 12, whereby the first contact portion 36a of each electrode 30 is brought into contact with and connected electrically to both the sealing layers 21a and 21b. The sealing layers 21a and 21b can be simultaneously energized by the electrodes 30 to heat and melt indium.

Other configurations of the second embodiment are the same as those of the foregoing first embodiment, so that like reference numerals are used to designate like portions, and a detailed description of those portions is omitted. Functions and effects similar to those of the first embodiment can be also obtained with the second embodiment. In the first and second embodiments, moreover, each electrode 30 may be fixedly mounted on the front substrate side.

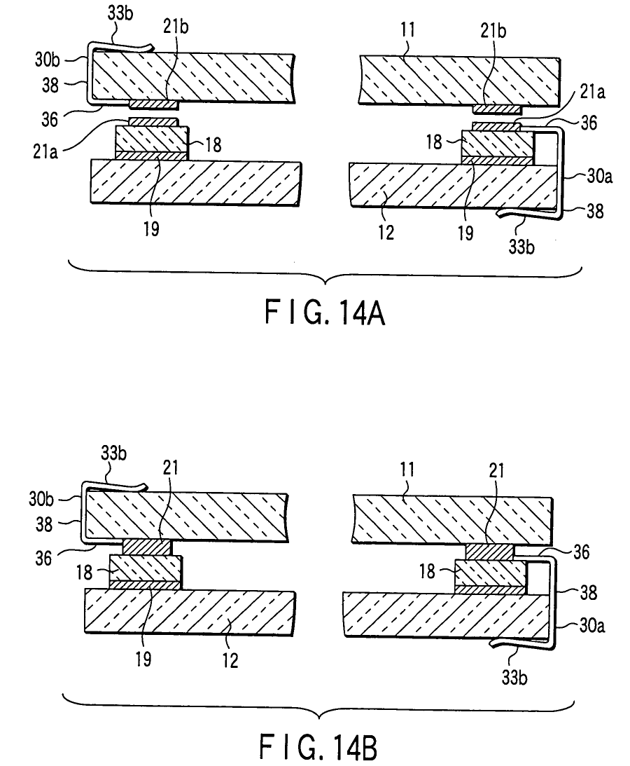

According to a third embodiment shown in FIGS. 13, 14A and 14B, an FED is provided with a pair of electrodes 30a, which serve to energize a sealing layer 21a formed on a sidewall 18, and a pair of electrodes 30b, which serve to energize a sealing layer 21b formed on the front substrate 11. The first and second electrodes 30a and 30b, which substantially resemble the aforementioned electrodes 30, are formed in the shape of a clip each. However, each electrode has one contact portion 36.

The paired first electrodes 30a are attached individually to a pair of corner portions that face each other in the diagonal direction of a rear substrate 12, and are mounted in a manner such that they elastically hold the sidewall 18 and the rear substrate 12 between them. In this case, each first electrode 30a is connected electrically to the sealing layer 21a with its contact portion 36 in contact with the sealing layer. The paired second electrodes 30b are attached individually to a pair of corner portions that face each other in the diagonal direction of the front substrate 11, and are mounted in a manner such that they elastically hold the front substrate. In this case, each second electrode 30b is connected electrically to the sealing layer 21b with its contact portion 36 in contact with the sealing layer. Preferably, the first electrodes 30a and the second electrodes 30b should be distributed individually in the four corner portions without overlapping one another.

In the sealing process, as shown in FIGS. 13 and 14A, a pair of connector terminals 40a that are connected to the power source 120 are brought individually into contact with respective conduction portions 38 of the first electrodes 30a, whereby electrical conduction is made between the power source and the first electrodes and between the first electrodes and the sealing layer 21a. Further, a pair of connector terminals 40b that are connected to the power source 120 are brought individually into contact with respective conduction portions 38 of the second electrodes 30b, whereby electrical conduction is made between the power source and the second electrodes and between the second electrodes and the sealing layer 21b. In this state, the sealing layer 21a on the side of the sidewall 18 and the sealing layer 21b on the side of the front substrate 11 are individually energized to be heated, thereby melting indium.

After the indium is melted, the front substrate 11 and the rear substrate 12 are pressurized in a direction such that they approach each other, as shown in FIG. 14B. Thereupon, the sealing layers 21a and 21b are fused together to form the sealing layer 21, and the peripheral edge portion of the front substrate 11 and the sidewall 18 are sealed together with the resulting sealing layer.

Other configurations of the third embodiment are the same as those of the foregoing first embodiment, so that like reference numerals are used to designate like portions, and a detailed description of those portions is omitted. Functions and effects similar to those of the first embodiment can be also obtained with the third embodiment. According to the third embodiment, moreover, the values of currents supplied to the sealing layer 21a on the side of the rear substrate 12 and the sealing layer 21b on the side of the front substrate 11 can be controlled individually, so that more appropriate electrical heating can be carried out.

The following is a description of an FED according to a fourth embodiment of this invention.

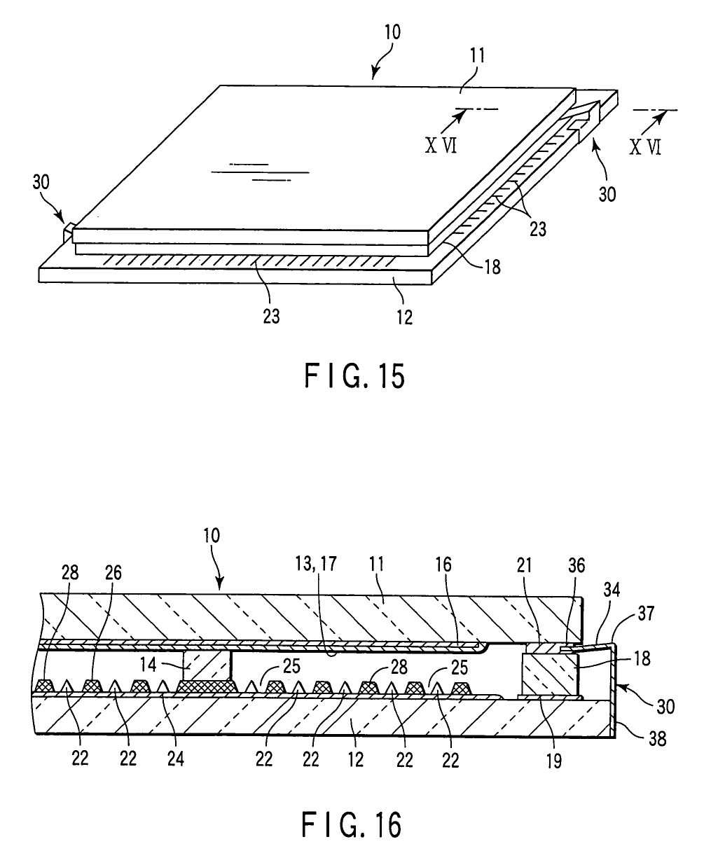

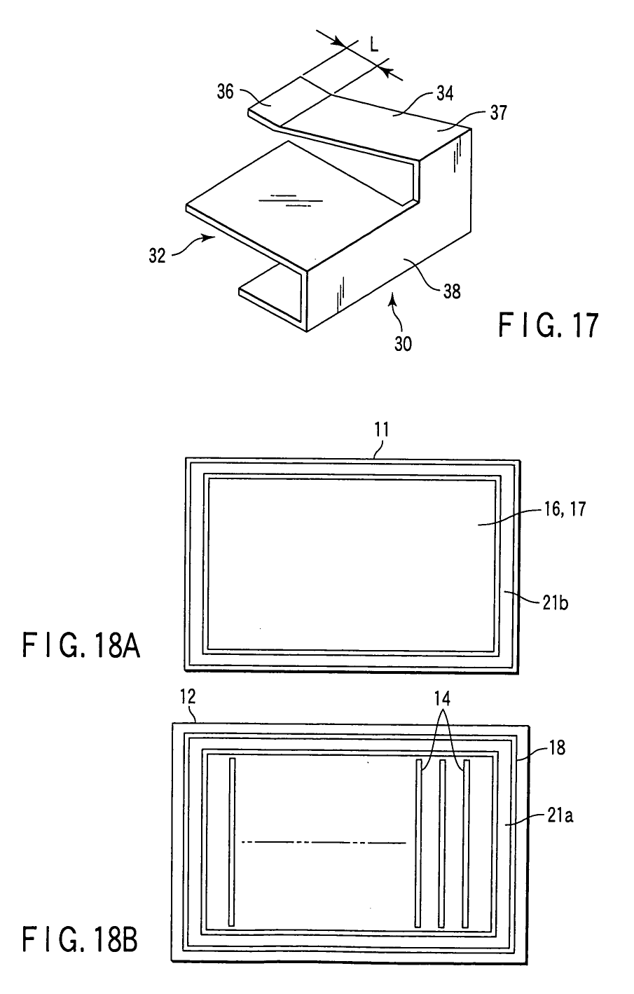

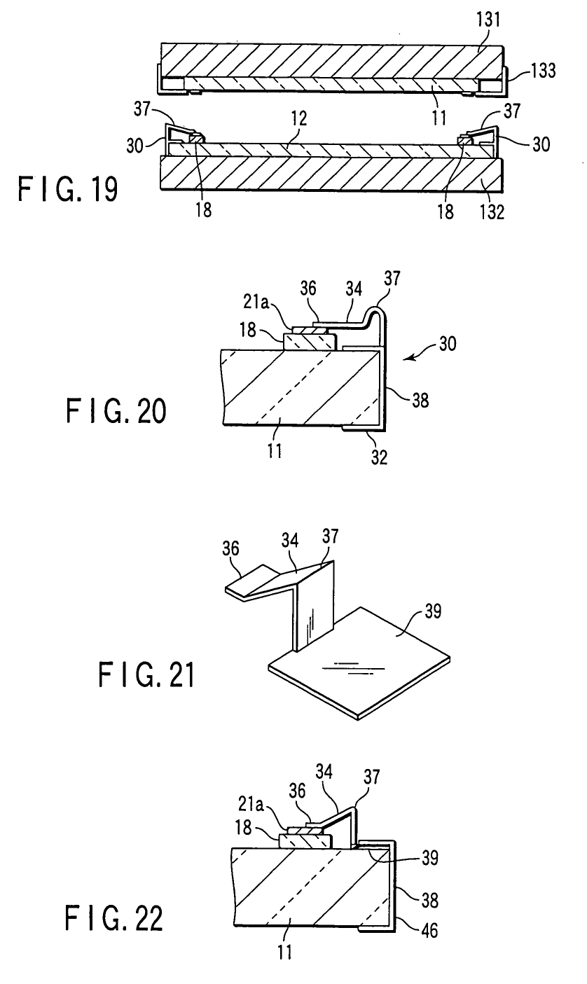

As shown in FIGS. 15 to 17, the FED is provided with a vacuum envelope 10 and a plurality of, e.g., a pair of, electrodes 30 attached to the vacuum envelope. The vacuum envelope 10 comprises a front substrate 11 and a rear substrate 12, which are formed of a rectangular glass sheet each. These substrates 11 and 12 have their respective peripheral edge portions joined together by a sidewall 18 in the form of a rectangular frame. A phosphor screen 16, a metal back 17, and a getter film 13 are formed on the inner surface of the front substrate 11. A large number of electron emitting elements 22 that excite phosphor layers of the phosphor screen 16 are arranged on the inner surface of the rear substrate 12. Further, a large number of wires 23 that supplies potential to the electron emitting elements 22 are arranged in a matrix on the inner surface of the rear substrate 12, and their respective end portions are drawn out to the peripheral edge portion of the vacuum envelope 10.

The paired electrodes 30 are attached to the envelope 10 in a manner such that they conduct electrically to a sealing layer 21. These electrodes 30 are used as electrodes for energizing the sealing layer 21. Each electrode 30 is formed by bending, for example, a copper sheet of 0.2-mm thickness as an electrically conductive member. More specifically, the electrode 30 is bent to have a substantially U-shaped profile. It integrally comprises a clip-shaped attachment portion 32, a wedge-shaped body portion 34 situated beside the attachment portion, a contact portion 36 situated on an extended end of the body portion, and a flat conduction portion 38 formed of the respective back parts of the attachment portion and the body portion. The attachment portion 32 can be attached to the front substrate 11 or the rear substrate 12 so as to nip the peripheral edge portion of the substrate. The contact portion 36 is formed having a horizontal extension length L of 2 mm or more. Further, the body portion 34 is in the form of a belt, which extends inclining outward and diagonally upward from the contact portion 36. Thus, the body portion 34 forms an outflow restraining portion 37 that is situated higher than the contact portion 36 with respect to the vertical direction.

Each electrode 30 is mounted in a manner such that it elastically engages, for example, the rear substrate 12 of the vacuum envelope 10. More specifically, the electrode 30 is attached to the vacuum envelope 10 with the peripheral edge portion of the rear substrate 12 elastically nipped by the attachment portion 32. The contact portion 36 of each electrode 30 touches and electrically conducts to the sealing layer 21. The body portion 34 extends from the contact portion 36 to the outside of the vacuum envelope 10, and the outflow restraining portion 37 is situated higher than the contact portion 36 with respect to the vertical direction. The conduction portion 38 is opposed to a side face of the rear substrate 12 and exposed on the outer surface of the vacuum envelope 10. These paired electrodes 30 are provided individually at two diagonally spaced corner portions of the vacuum envelope 10 and located symmetrically with respect to the sealing layer 21.

Other configurations of the FED described above are the same as those of the foregoing first embodiment, so that like reference numerals are used to designate like portions, and a detailed description of those portions is omitted.

The following is a detailed description of a method of manufacturing the above-described FED. This manufacturing method is substantially the same as the manufacturing method according to the first embodiment, so that the following description is focused on different portions.

First, the front substrate 11 having the phosphor screen and the metal back 17 formed thereon and the rear substrate 12 having the electron emitting elements 22 thereon are prepared. Subsequently, the metal back 17 and support members 14 are sealed onto the inner surface of the rear substrate 12 with low-melting glass 19 in the atmosphere. Thereafter, a sealing layer 21a is formed by spreading indium to a given width and thickness over the entire periphery of a seal surface of the sidewall 18, as shown in FIGS. 18A and 18B. A sealing layer 21b is formed by spreading indium in the shape of a rectangular frame with a given width and thickness over a seal surface of the front substrate 11 that faces the sidewall. As mentioned before, moreover, the sealing layers 21a and 21b are loaded onto the respective seal surfaces of the sidewall 18 and the front substrate 11 by a method in which melted indium is applied to the seal surfaces or a method such that solid indium is placed on the seal surfaces.

Subsequently, the paired electrodes 30 are mounted on the rear substrate 12 to which the sidewall 18 is joined. As this is done, the contact portion 36 of each electrode 30 is brought into contact with the sealing layer 21a, whereby the electrode is connected electrically to the sealing layer. The paired electrodes 30 are attached individually to the two corner portions that face each other in the diagonal direction of the rear substrate 12, and the respective lengths of the sealing layers 21a and 21b that are situated between the electrodes are set to be substantially equal on the opposite sides of each electrode.

After the electrodes 30 are mounted, the rear substrate 12 and the front substrate 11 are opposed to each other at a given space, and in this state, put into the vacuum processor shown in FIG. 9. The front substrate 11 and the rear substrate 12 are fed into the baking/electron beam cleaning chamber 102 through the loading chamber 101. In the baking/electron beam cleaning chamber 102, the individual members are heated to a temperature of 300° C., and the surface-adsorbed gas is released from each substrate. At the same time, electron beams emitted from the electron beam generator are applied to a phosphor screen surface of the front substrate 11 and electron emitting element surfaces of the rear substrate 12, whereby the phosphor screen surface and the electron emitting element surfaces are individually entirely cleaned with the electron beams.

The sealing layers 21a and 21b are heated to be melted in a baking process. The sealing layer 21a on the side of the rear substrate 12 is motivated to flow out through the electrodes 30. Since each electrode 30 is provided with the outflow restraining portion 37 that is situated higher than the contact portion 36, however, the outflow restraining portion can restrain melted indium from flowing out of the rear substrate.

After the front substrate 11 and the rear substrate 12 are then fed into the cooling chamber 103 and cooled to a temperature of about 120° C., they are delivered to the vapor deposition chamber 104 for getter film, whereupon a Ba film is formed on the outside of the phosphor layers by vapor deposition. Subsequently, the front substrate 11 and the rear substrate 12 are fed into the assembly chamber 105, whereupon they are held opposite to each other by hotplates 131 and 132, respectively, in the assembly chamber. The front substrate 11 is fixed to the upper hotplate 131 with a fixing jig 133 lest it fall.

Thereafter, the front substrate 11 and the rear substrate 12 are kept at about 120° as they are moved toward each other and pressurized under a given pressure. By doing this, the contact portion 36 of each electrode 30 is sandwiched between the sealing layer 21b on the side of the front substrate 11 and the sealing layer 21a on the side of the rear substrate 12 so that each electrode 30 is connected electrically to the sealing layers 21a and 21b. In this case, the contact portion 36 is formed having a horizontal length of 2 mm or more, so that it can be brought stably into contact with the sealing layers 21a and 21b. If indium is previously spread over the contact portion 36 of the electrode 30, the sealing material can be energized more stably.

After the power source 120 is connected electrically to the pair of electrodes 30 in this state, a DC current of, e.g., 140 A is applied to the sealing layer 21a on the side of the sidewall 18 and the sealing layer 21b on the side of the front substrate 11 in a constant-current mode. By doing this, the sealing layers 21a and 21b are heated so that the indium melts. As this is done, electrical conduction between the power source 120 and the electrodes 30 and between the electrodes and the sealing layers 21a and 21b can be secured by bringing connector terminals connected to the power source into contact with the conduction portions 38 of the electrodes. Since each electrode 30 is equivalently in contact with the sealing layers 21a and 21b, moreover, stable electrical conduction can be ensured, so that the individual sealing layers can be supplied with currents of substantially equal magnitudes and equally melted.

By melting the indium in this manner, the sealing layers 21a and 21b are fused together to form the sealing layer 21, and the peripheral edge portion of the front substrate 11 and the sidewall 18 are sealed together with the resulting sealing layer. The vacuum envelope 10, formed in the processes described above, is cooled to normal temperature in the cooling chamber 106 and taken out of the unloading chamber 107. Thus, the vacuum envelope 10 of the FED is completed. If necessary, the electrodes 30 may be cut off after the vacuum envelope 10 is completed.

According to the FED constructed in this manner and its manufacturing method, functions and effects similar to those of the first embodiment can be obtained. According to the fourth embodiment, moreover, the electrodes 30 for energizing the sealing material each have the outflow restraining portion that is situated higher than the contact portion, which restrains the melted sealing material from flowing out through each electrode in the baking process or the like. Accordingly, the thickness of the sealing layer can be kept uniform, so that the envelope can be securely sealed throughout its circumference, and shorting of the wires or the like that is attributable to the outflow of the sealing material can be prevented. Thus, an FED can be obtained at low cost that ensures outstanding mass-productivity and, at the same time, formation of stable satisfactory images.

In the fourth embodiment described above, substantially the whole of the body portion 34 of each electrode 30 is formed having the outflow restraining portion 37 that extends diagonally upward from the contact portion 36. Alternatively, however, the outflow restraining portion 37 may be formed of a part of the body portion 34 that extends to a position higher than the contact portion 36 with respect to the vertical direction, as shown in FIG. 20, for example. Although each electrode 30 is provided integrally with the attachment portion, moreover, the electrode 30 may alternatively be provided with the contact portion 36, the body portion 34, the outflow restraining portion 37, and a base portion 39, as shown in FIGS. 21 and 22. In this case, the electrode 30 is attached to the rear substrate 12 with a separate clip 46.

Other configurations of the modifications shown in FIGS. 20 to 22 are the same as those of the foregoing fourth embodiment, so that like reference numerals are used to designate like portions, and a detailed description of those portions is omitted. Functions and effects similar to those of the foregoing embodiment can be also obtained with use of the electrodes according to these modifications.

The following is a description of an FED according to a fifth embodiment of this invention.

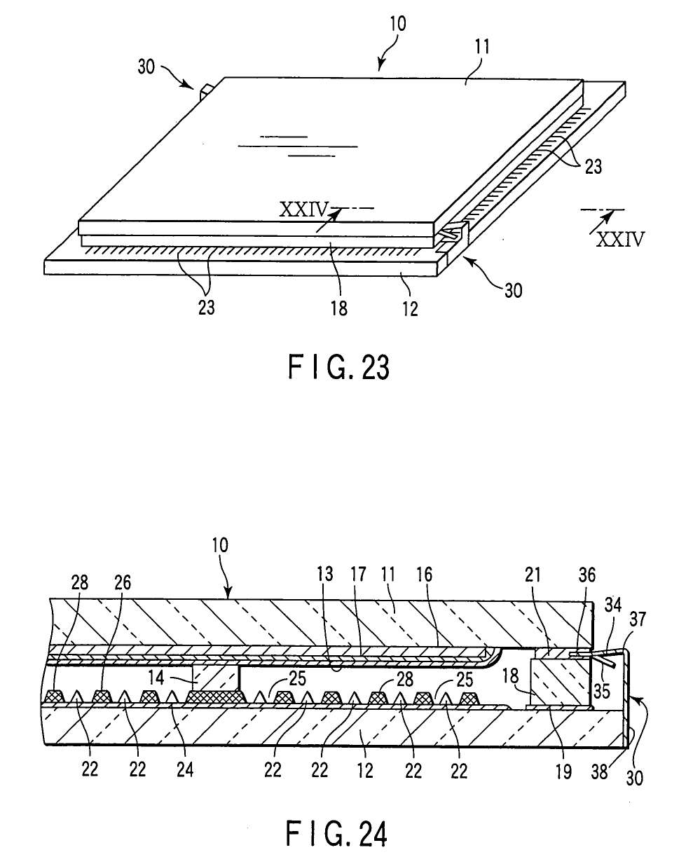

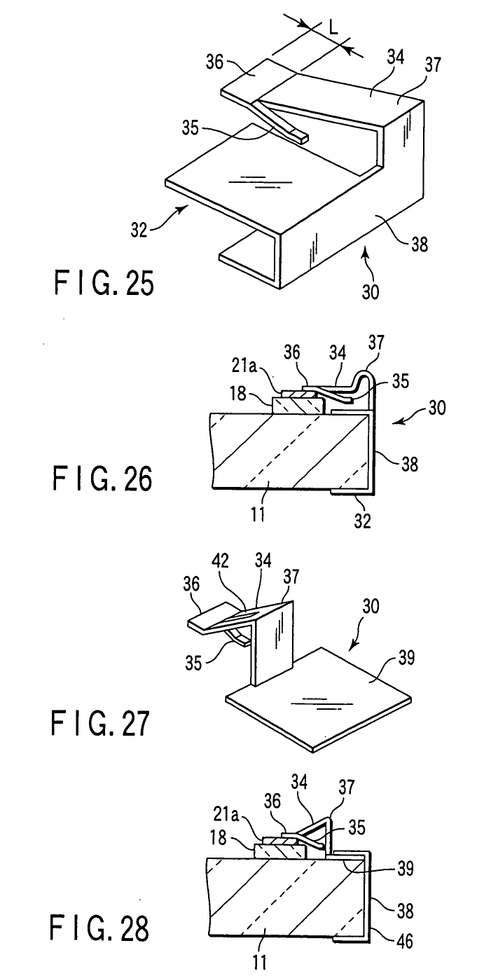

As shown in FIGS. 23 to 25, the FED is-provided with a vacuum envelope 10 and a plurality of, e.g., a pair of, electrodes 30 attached to the vacuum envelope. The paired electrodes 30 are attached to the envelope in a manner such that they conduct electrically to a sealing layer 21. Each electrode 30 is formed by bending, for example, a copper sheet of 0.2-mm thickness as an electrically conductive member. More specifically, the electrode 30 is bent to have a substantially U-shaped profile. It integrally comprises a clip-shaped attachment portion 32, a wedgeshaped body portion 34 situated beside the attachment portion, a contact portion 36 situated on an extended end of the body portion, a drain portion 35 extending from the contact portion to the body portion side and situated beside the body portion, and a flat conduction portion 38 formed of the respective back parts of the attachment portion and the body portion. The attachment portion 32 can be attached to a front substrate 11 or a rear substrate 12 so as to nip the peripheral edge portion of the substrate.

The contact portion 36 is formed having a horizontal extension length L of 2 mm or more. The body portion 34 is in the form of a belt, which obliquely extends outward and diagonally upward from the contact portion 36. Thus, the body portion 34 forms an outflow restraining portion 37 that is situated higher than the contact portion 36 with respect to the vertical direction. The body portion 34 forms a passage through which current is caused to flow from the conduction portion 38 to the contact portion 36.

The drain portion 35 is in the form of a belt, which obliquely extends outward and diagonally downward from the contact portion 36. Thus, the drain portion 35 is formed in a position lower than the contact portion 36 with respect to the vertical direction. The width of the drain portion 35, which is narrower than the width of the body portion 34, is set to about 1 mm, for example. As mentioned later, the drain portion 35 defines a passage through which a melted sealing material is allowed to flow out.

Each electrode 30 is mounted in a manner such that it elastically engages, for example, the rear substrate 12 of the vacuum envelope 10. More specifically, the electrode 30 is attached to the vacuum envelope 10 with the peripheral edge portion of the rear substrate 12 elastically nipped by the attachment portion 32. The contact portion 36 of each electrode 30 touches and electrically conducts to the sealing layer 21. The body portion 34 extends from the contact portion 36 to the outside of the vacuum envelope 10, and the outflow restraining portion 37 is situated higher than the contact portion 36 with respect to the vertical direction. The drain portion 35 extends to the outside of the vacuum envelope 10 and is situated in a position lower than the contact portion 36 with respect to the vertical direction. The conduction portion 38 is opposed to a side face of the rear substrate 12 and exposed on the outer surface of the vacuum envelope 10. These paired electrodes 30 are provided individually at two diagonally spaced corner portions of the vacuum envelope 10 and located symmetrically with respect to the sealing layer 21.

Other configurations of the FED described above are the same as those of the foregoing fourth embodiment, so that like reference numerals are used to designate like portions, and a detailed description of those portions is omitted. Further, the FED according to the fifth embodiment is manufactured by the same manufacturing method as the manufacturing method according to the fourth embodiment.

According to the fifth embodiment, sealing layers 21a and 21b are heated to be melted in a baking process. The sealing layer 21a on the side of the rear substrate 12 is motivated to flow out through the electrodes 30. Since each electrode 30 is provided with the outflow restraining portion 37 that is situated higher than the contact portion 36, however, the outflow restraining portion can restrain melted indium from flowing out of the rear substrate. Further, some of the melted indium flows out of the rear substrate 12 via the drain portion 35 of each electrode 30. Since the width of the drain portion is narrower than the width of the body portion 34, however, the outflow rate is low. For example, the outflow rate of melted indium can be restricted to about 1/10 of that for an electrode that has neither the outflow restraining portion 37 nor the drain portion. There is no possibility of the outflow rate of this level arousing a problem that the sealing layers are relatively thin and easily allow leakage through sealed portions or a problem that the outflow of indium touches wires on the substrates and causes short-circuiting.

In the sealing process, moreover, the sealing layers 21a and 21b are fused together to form the sealing layer 21, and the peripheral edge portion of the front substrate 11 and the sidewall 18 are sealed together with the resulting sealing layer. Since the front substrate 11 and the rear substrate 12 are pressurized in a direction such that they approach each other, in this case, the melted indium is flattened so that surplus indium is produced. The surplus indium is motivated to flow out to the substrate side. Since each electrode 30 is provided with the drain portion 35 that is situated lower than the contact portion 36, however, the melted surplus indium positively flows out via the drain portion 35 to the outside of the substrates. More specifically, the drain portion 35 of the electrode 30 is narrower than the body portion 34. Since the indium is pressurized, however, the surplus indium is carried away along the drain portions 35 of all the electrodes toward the peripheral edges of the substrates. Each electrode 30 is attached to a corner portion of the rear substrate 12, and the drain portion 35 extends in a position off wires 23. Therefore, the indium having flowed out along the drain portion 35 never touches the wires 23, so that shorting of the wires or the like by the runoff indium can be prevented. If the indium is previously spread over the drain portions 35 of the electrodes 30 and regions near them, the sealing material can be allowed to flow out more stably.

Furthermore, functions and effects similar to those of the foregoing first embodiment can be obtained according to the FED of the fifth embodiment and its manufacturing method.

In the fifth embodiment, substantially the whole of the body portion 34 of each electrode 30 is formed having the outflow restraining portion 37 that extends diagonally upward from the contact portion. Alternatively, however, the outflow restraining portion 37 may be formed of a part of the body portion 34 that extends to a position higher than the contact portion 36 with respect to the vertical direction, as shown in FIG. 26, for example.

Although each electrode 30 is provided integrally with the attachment portion according to the fifth embodiment, moreover, it may alternatively be provided with the contact portion 36, the body portion 34, the outflow restraining portion 37, the drain portion 35, and a base portion 39, as shown in FIGS. 27 and 28. In this case, the electrode 30 is attached to the rear substrate 12 with a separate clip 46 that has the conduction portion 38.

The drain portion 35 of the electrode 30 need not always be provided beside the body portion 34, and may alternatively be provided in the central part of the body portion 34, as shown in FIG. 27. In this case, the drain portion 35 is formed by cutting and raising a part of the body portion 34, and the body portion is formed having an aperture 42 that allows the sealing material to flow out from the contact portion 36 to the drain portion 35.

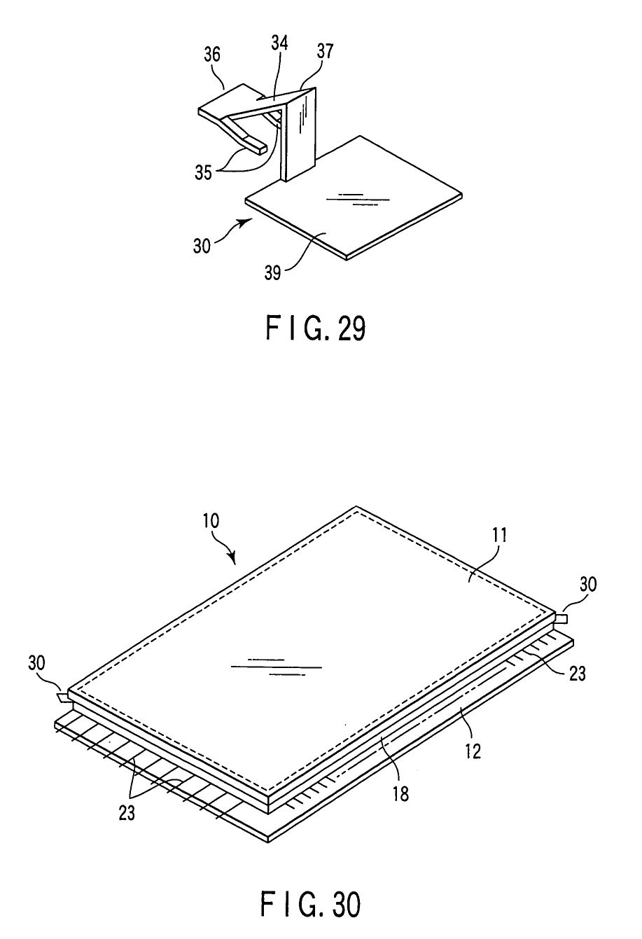

As shown in FIG. 29, the drain portion 35 of the electrode 30 is not limited to one in number, and a pair of drain portions may be provided on either side of the body portion 34. In this case, each drain portion 35 is constructed in the same manner as that of the foregoing embodiment.

Other configurations of the modifications shown in FIGS. 26 to 29 are the same as those of the foregoing fifth embodiment, so that like reference numerals are used to designate like portions, and a detailed description of those portions is omitted. Functions and effects similar to those of the foregoing embodiment can be also obtained with use of the electrodes according to these modifications. Further, the foregoing embodiment and the modifications shown in FIGS. 26 to 29 may be combined with one another.

The following is a description of an FED according to a sixth embodiment of this invention and its manufacturing method. As shown in FIG. 30, the FED is provided with a flat, rectangular vacuum envelope 10 and a plurality of, e.g., a pair of, electrodes 30 attached to the vacuum envelope. The configuration of the FED of the sixth embodiment, exclusive of the electrodes 30, is the same as those of the foregoing embodiments, so that the following description is focused on different configurations. At the same time, the configuration of the FED will be described along with the manufacturing method.

As shown in FIGS. 13A and 13B, a front substrate 11 having a phosphor screen 16 and a metal back 17 formed thereon and a rear substrate 12 having electron emitting elements thereon are prepared. Subsequently, a sidewall 18 and support members 14 are sealed onto the inner surface of the rear substrate 12 with low-melting glass in the atmosphere. Thereafter, a sealing layer 21a in the shape of a rectangular frame is formed by spreading indium to a given width and thickness over the entire periphery of a seal surface of the sidewall 18. A sealing layer 21b in the shape of a rectangular frame corresponding to the sealing layer 21a on the side of the front substrate 11 is formed by spreading indium in the shape of a rectangular frame with a given width and thickness over a seal surface of the front substrate 11 that faces the sidewall. As mentioned before, moreover, the sealing layers 21a and 21b are loaded onto the respective seal surfaces of the sidewall 18 and the front substrate 11 by a method in which melted indium is applied to the seal surfaces or a method such that solid indium is placed on the seal surfaces.

Subsequently, the front substrate 11 and the rear substrate 12 are fed into the vacuum processor shown in FIG. 9, for example, and sealed together in a vacuum atmosphere. In this case, the front substrate 11 and the rear substrate 12 are heated and thoroughly degassed. The heating temperature is fitly set to about 200° C. to 500° C. The degassing process reduces a gas that is released from the inner walls of the component members of the envelope, thereby preventing the degree of vacuum of the vacuum envelope from lowering. Then, a getter film is formed on the phosphor screen 16 of the front substrate 11. This is done in order to adsorb and discharge a residual gas after the vacuum envelope is formed, thereby keeping the degree of vacuum in the vacuum envelope at a satisfactory level.

Subsequently, the front substrate 11 and the rear substrate 12 are overlapped on each other in a predetermined position such that the phosphor screen 16 and the phosphor screen 16 face the electron emitting elements. In this state, the sealing layers 21a and 21b are energized, whereupon their sealing material is heated to be melted. Thereafter, the energization is stopped, and heat from the sealing layers 21a and 21b is quickly diffusively transferred to the front substrate 11 and the sidewall 18, whereupon the sealing layers 21a and 21b are solidified. In consequence, the front substrate 11 and the sidewall 18 are sealed together with the sealing layers 21a and 21b.

The following is a further detailed description of the sealing process described above.

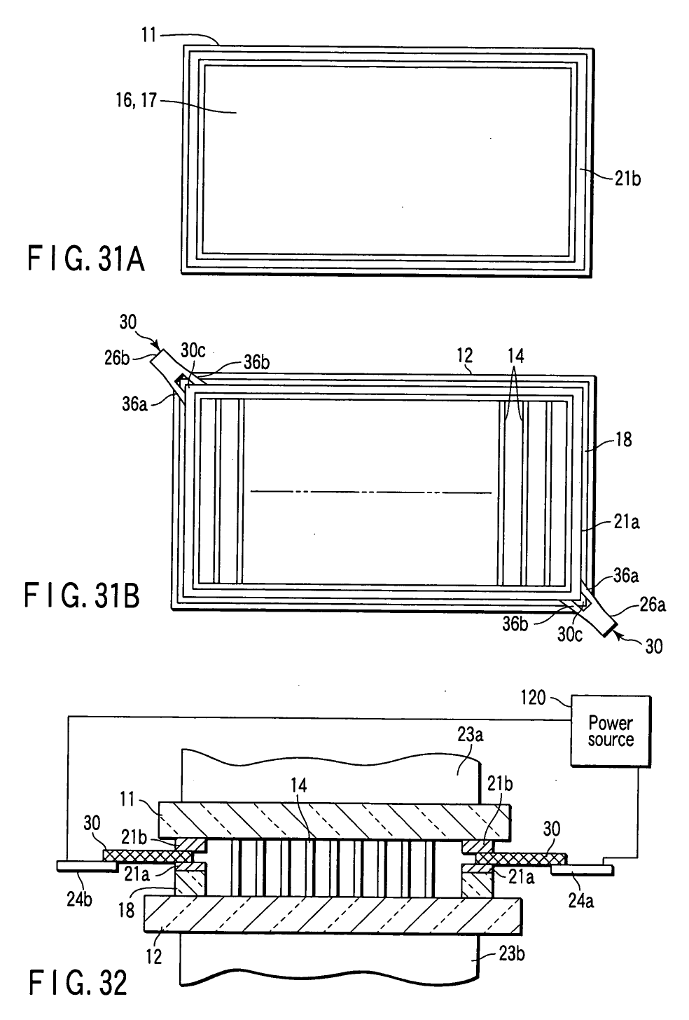

In a state before sealing, as shown in FIGS. 31 and 32, the temperature of the front substrate 11 and the rear substrate 12 is set to be lower than the melting point of the sealing layers 21a and 21b, so that the sealing layers 21a and 21b are solid. In this state, the front substrate 11 and the rear substrate 12 are overlapped in a predetermined position, and the sealing layers 21a and 21b are overlapped on each other. Further, a given load is applied to the front substrate 11 and the rear substrate 12 by pressurizers 23a and 23b in a direction such that they approach each other. An image display region is held in a predetermined gap by the support members 14.

As this is done, the sheetlike electrodes 30 are sandwiched individually between the sealing layers 21a and 21b at two diagonally spaced corner portions of the sidewall 18. As shown in FIG. 31B, each electrode 30 has two contact portions 36a and 36b that are in electrical contact with the sealing layers, individually, and is substantially Y-shaped. The contact portions 36a and 36b of each electrode 30 touch the sealing layers 21a and 21b on either side of the corner portions of the sealing layers. Defined between the two contact portions 36a and 36b is a gap 30c that allows the melted sealing material to flow out. The electrodes 30 may be sandwiched by a method in which they are fixed with a clip or the like of the same material as the electrodes. The electrodes 30 are formed of a simple element or an alloy that contains Cu, Al, Fe, Ni, Co, Be and/or Cr.

Subsequently, feed terminals 24a and 24b are brought into contact with the electrodes 30, individually. These feed terminals 24a and 24b are connected to the power source 120. If a given current is supplied to the sealing layers 21a and 21b through the feed terminals 24a and 24b and the electrodes 30 in this state, only the sealing layers 21a and 21b generate heat and melt. As this is done, the melted surplus sealing material flows out of the sidewall 18 through the corner portions of the sidewall via the gap 30c that is surrounded by the sealing layers and the two contact portions 36a and 36b of each electrode 30.

If the feed terminals 24a and 24b are removed with the current supply stopped, thereafter, heat from the sealing layers 21a and 21b that have a small heat capacity is radiated to the front substrate 11 and the sidewall 18, owing to a temperature gradient. The sealing layers 21a and 21b reach thermal equilibrium with the front substrate 11 and the sidewall 18 that have a large heat capacity, and are quickly cooled to be solidified. Thus, the front substrate 11 and the sidewall 18 are sealed together with the sealing layers 21a and 21b, whereupon the FED can be obtained having the vacuum envelope 10 in which a high vacuum is maintained. After the sealing, the electrodes 30 are fixed to the vacuum envelope 10 in a manner such that they are sealed together with the sealing layers 21a and 21b.

According to the FED of the sixth embodiment constructed in this manner and its manufacturing method, the vacuum envelope can be vacuum-sealed in a very short time by a simple manufacturing apparatus. More specifically, with use of the electrically conductive sealing material, only the sealing material, which has a small heat capacity or a small volume, can be selectively heated without heating the substrates. Thus, lowering of the positional accuracy or the like that is attributable to thermal expansion of the substrates can be restrained from being lowered Since the heat capacity of the sealing layers is much smaller than the heat capacity of the substrates, the heating and cooling times can be made much shorter than in the case of the conventional method in which the substrates are heated entirely, so that the mass-productivity can be improved considerably. Further, necessary equipment for sealing includes only the mere feed terminals and a mechanism for their contact. Thus, a clean apparatus can be realized that is very simple and suited for ultrahigh vacuum use.

Each electrode 30 for energizing the sealing layers 21a and 21b has a plurality of contact portions 36a and 36b, and the gap 30c is defined between these contact portions. During the sealing operation, therefore, the melted surplus sealing material can be allowed positively to flow out through the gap 30c that is defined between the contact portions 36a and 36b. Thus, with the contact portions of the electrodes 30 arranged in proper positions, the sealing material can be prevented from overhanging wires of the substrates or the like, so that sealing can be carried out quickly and steadily without causing any short circuit or the like between the wires.

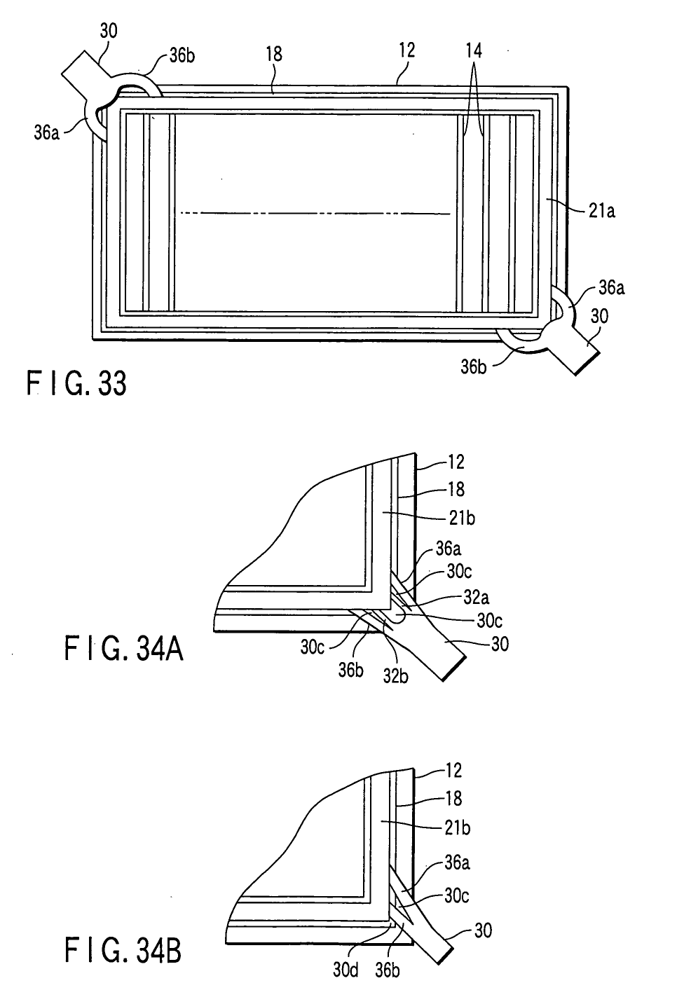

Each electrode 30 is expected only to have a gap between the contact portions through which the sealing material passes, and its shape is not limited to the aforesaid shape of a Y. For example, it may be substantially U-shaped, as shown in FIG. 33. Each electrode 30 may have three or more contact portions that are in contact with the sealing material. As shown in FIG. 34A, for example, the electrode 30 may be shaped like a broom having four contact portions 36a, 36b, 32a and 32b. In this case, gaps 30c through which the sealing material is passed are formed individually between the adjacent contact portions.

Further, the contact portions of each electrode 30 need not always be located on either side of a corner portion of the vacuum envelope, and may alternatively be located on one side of a corner portion of the envelope as they are in contact with the sealing layers 21a and 21b. Since the electrode 30 is slightly deviated from the corner portion, the sealing material sometimes may flow out through a corner portion 30d of the envelope. Other configurations of the modifications shown individually in FIGS. 33, 34a and 34B are the same as those of the foregoing embodiment, so that like reference numerals are used to designate like portions, and a detailed description of those portions is omitted. Functions and effects similar to those of the sixth embodiment can be also obtained with these modifications.

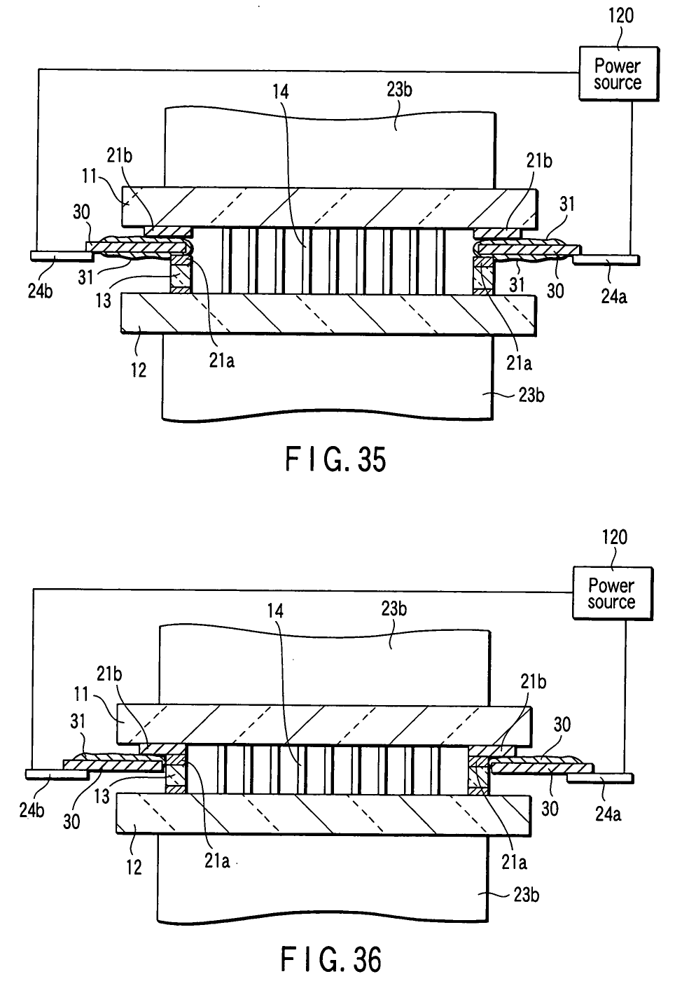

In the foregoing sixth embodiment, the contact portions 36a and 36b are configured directly to touch the sealing layers 21a and 21b. According to a manufacturing method of a seventh embodiment shown in FIG. 35, however, each electrode 30 may be previously covered by an electrically conductive material layer 31. In this case, the electrode is brought into contact with sealing layers through the electrically conductive material layer 31.

More specifically, a pair of sheetlike electrodes 30 are sandwiched individually between a sealing layer 21a and a sealing layer 21b in the sealing process. Those surfaces of each electrode 30 which individually touch the sealing layers 21a and 21b are previously covered by the electrically conductive material layer 31. In this case, the opposite surfaces of each electrode 30 are coated with In, which is the same electrically conductive material for the sealing layers 21a and 21b, or an alloy that contains In, for example. The electrically conductive material layer 31 is formed by spreading an electrically conductive material over the electrode surfaces with a soldering iron that is subjected to ultrasonic wave application, for example. Thus, each electrode 30 is in contact with the sealing layers 21a and 21b with the electrically conductive material layer 31 therebetween. The electrodes 30 are formed of a simple element or an alloy that contains Cu, Al, Fe, Ni, Co, Be and/or Cr.

Subsequently, feed terminals 24a and 24b are brought into contact with the electrodes 30, individually. These feed terminals 24a and 24b are connected to the power source 120. If a given current is supplied to the sealing layers 21a and 21b through the feed terminals 24a and 24b and the electrodes 30 in this state, only the sealing material generates heat and melts. If the feed terminals 24a and 24b are removed with the current supply stopped, thereafter, heat from the sealing layers 21a and 21b that have a small heat capacity is radiated to the front substrate 11 and the sidewall 18, owing to a temperature gradient. Thereupon, the sealing layers 21a and 21b reach thermal equilibrium with the front substrate 11 and the sidewall 18 that have a large heat capacity, and are quickly cooled to be solidified. Thus, the front substrate 11 and the sidewall 18 are sealed together with the sealing layers 21a and 21b, whereupon an FED can be obtained having a vacuum envelope 10 in which a high vacuum is maintained. After the sealing, the electrodes 30 are fixed to the vacuum envelope 10 in a manner such that they are sealed together with the sealing layers 21a and 21b.

Other configurations of the seventh embodiment are the same as those of the foregoing sixth embodiment, so that like reference numerals are used to designate like portions, and a detailed description of those portions is omitted. Functions and effects similar to those of the sixth embodiment can be also obtained with the seventh embodiment. Those surfaces of each electrode 30 for the energization of the sealing layers 21a and 21b which individually touch the sealing layers are covered by the electrically conductive material layer 31. When the sealing layers 21a and 21b are energized and melted, therefore, wettability between the electrodes 30 and the sealing material is improved, so that the contact resistance between the sealing material and the electrodes can be prevented from increasing. Thus, extraordinary heat generation at the contact portions can be prevented, so that the possibility of disconnection of the sealing layers 21a and 21b can be eliminated. In consequence, the FED can be manufactured with high yield in a short time.

As the surfaces of each electrode 30 are covered by the electrically conductive material layer 31, moreover, the melted sealing material that overruns during the sealing operation can be positively discharged from the electrode to the outside of the envelope.

Although the electrodes 30 are sandwiched between the sealing layers 21a and 21b according to the foregoing seventh embodiment, the electrodes may alternatively be brought into contact with only one of the sealing members when they are energized. More specifically, the front substrate 11 and the rear substrate 12 are overlapped in a predetermined position, and the sealing layers 21a and 21b are overlapped to be in contact with each other, as shown in FIG. 36. A given sealing load is applied to the front substrate 11 and the rear substrate 12 by pressurizers 23a and 23b in a direction such that they approach each other. The electrodes 30 are individually located in contact with the sealing member 21b.

The method for holding the electrodes may be a method in which the electrodes are fixed with a clip or the like of the same material as the sealing layers so that they are previously in contact with the sealing layers 21a and 21b of the front substrate 11 or a method in which the electrodes are fixedly held on the feed terminals 24a and 24b with a clip or the like and the electrodes are sandwiched between the front substrate 11 and the rear substrate 12 when the substrates are overlapped in the predetermined position.

In this case, that surface of each electrode 30 which touches the sealing layer 21b is previously covered by the electrically conductive material layer 31. The electrically conductive material layer 31 is formed by spreading an electrically conductive material over the electrode surfaces with a soldering iron that is subjected to ultrasonic wave application, for example. In order to cause the surplus sealing material positively to overrun the electrode 30 during the sealing operation, the electrically conductive material layer may be also formed on those surfaces of the electrode which are not in contact with the sealing material of the electrode 30.

Other configurations are the same as those of the foregoing seventh embodiment, so that like reference numerals are used to designate like portions, and a detailed description of those portions is omitted. Functions and effects similar to those of the seventh embodiment can be also obtained with the arrangement described above.

The current that is supplied to the sealing material is not limited to a DC current, and may alternatively be an AC current that varies at commercial frequency. In this case, the trouble of purposely converting commercial current that is transmitted in AC mode into DC current can be saved, and the apparatus can be simplified. Further, ac current that varies at high frequency on the kHz level may be used instead. In this case, the skin effect makes the Joule heat increase in proportion to the increase of effective resistance relative to high frequency, so that the same heating effect as aforesaid can be obtained with use of a smaller current value.

According to the embodiment described above, moreover, the time for energization with electric power is adjusted to about 5 to 300 seconds. If the energization time is long (or if the power is low), a rise in temperature around the substrates causes troubles, such as lowering of cooling speed and thermal expansion. If the energization time is short (or if the power is high), the electrically conductive sealing material suffers disconnection attributable to uneven filling or is cracked by glass thermal stress. Preferably, therefore, the power and time (including change of power with time) for energization should be set to optimum conditions for each object to be energized.

According to the embodiment described above, moreover, the temperature difference between the substrate temperature during the sealing operation and the melting point of the sealing material is adjusted to about 20° C. to 150° C. If the temperature difference is large, the glass thermal stress increases, although the cooling time can be shortened. Preferably, therefore, the temperature difference should be also set to an optimum condition for each object to be energized.

The following is a description of a method of manufacturing an FED according to an eighth embodiment of this invention. The configuration of the FED and the manufacturing method of the eighth embodiment, exclusive of the sealing process, are the same as those of the foregoing sixth embodiment, so that the following description is focused on different portions.

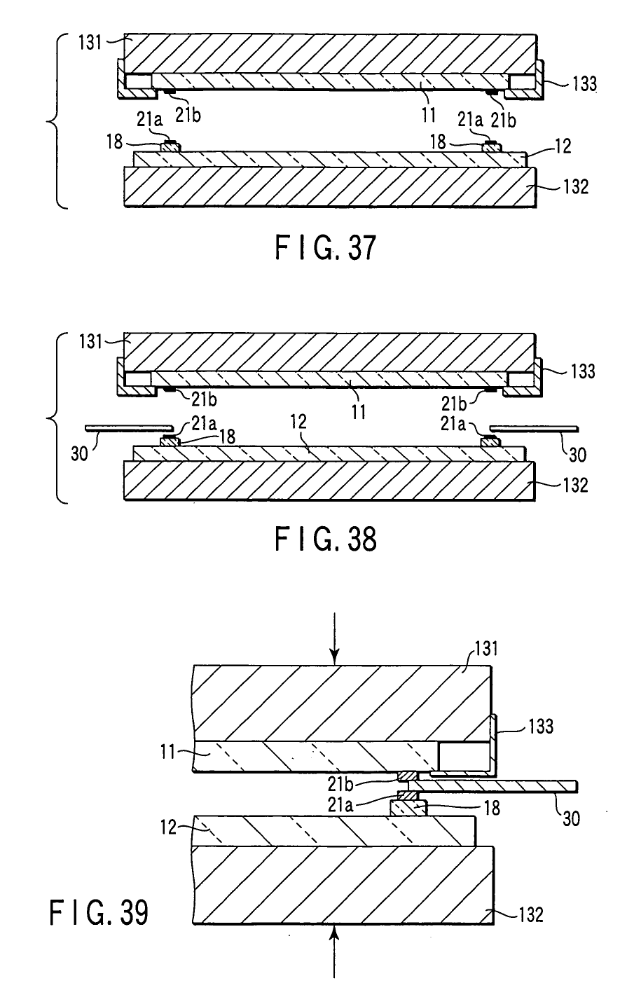

In the sealing process, as shown in FIG. 37, a front substrate 11 and a rear substrate 12 that are fed into the assembly chamber of the vacuum processor are kept opposite to each other as they are held on the hotplates 131 and 132, respectively, with their respective outer surfaces intimately in contact therewith. More specifically, the rear substrate 12 is placed on the hotplate 132, while the front substrate 11 is fixed to the upper hotplate 131 with the fixing jig 133 lest it fall.

Subsequently, as shown in FIGS. 38 and 39, a pair of flat electrodes 30 of, e.g., copper with a thickness of about 0.2 mm each are prepared, and these electrodes 30 are inserted between the front substrate 11 and the rear substrate 12. In doing this, the paired electrodes 30 are located in opposite positions and inserted so that the respective distal ends of the electrodes are situated between a sealing layer 21b on the side of the front substrate 11 and a sealing layer 21a on the side of the rear substrate 12. For example, the paired electrodes 30 are located corresponding individually to two diagonally opposite corner portions, two short sides, or two long sides of each substrate.

Then, the upper hotplate 131 and the front substrate 11 are lowered so that substantially the whole of the sealing layer 21b on the front substrate 11 is brought into contact with the sealing layer 21a on a sidewall 18 on the rear substrate side. At the same time, the front substrate 11 and/or the rear substrate 12 or both the substrates for this case are pressurized under a given pressure in a direction such that they approach each other. In doing this, each electrode 30 is sandwiched between the upper and lower sealing layers 21a and 21b. Thereupon, each electrode 30 comes into electrical contact with upper and lower indiums 21 at one time.

In this state, a dc current of 140 A is supplied from the power source to the two sealing layers 21a and 21b through the paired electrodes 30 in a constant-current mode. As this is done, the indium that forms the sealing layers is heated to be melted, whereupon the front substrate 11 and the sidewall 18 are airtightly joined together with the sealing layers 21a and 21b.

When the current supply is stopped, thereafter, the melted indium solidifies, whereupon the envelope 10 is formed. The envelope formed in this manner is cooled to normal temperature in the cooling chamber 106 and taken out of the unloading chamber 107. In this process, the vacuum envelope is completed.

According to the eighth embodiment, as in the foregoing embodiments, the front substrate 11 and the rear substrate 12 are sealed and joined together in a vacuum atmosphere. Therefore, the surface-adsorbed gas can be satisfactorily discharged by combining baking and electron beam cleaning, and a getter film with excellent adsorption capacity can be obtained. Since the front substrate and the rear substrate are sealed and joined together by electrically heating the indium, moreover, they need not be entirely heated, and deterioration of the getter film, cracking of the substrates during the sealing process, or other failure can be avoided. At the same time, the sealing time can be shortened, so that the manufacturing method can enjoy outstanding mass-productivity.

Further, at least one of the opposed front and rear substrates 11 and 12 is pressurized in a direction such that the front substrate and the rear substrate approach each other, and the sealing layers 21a and 21b are energized and heat-melted with at least parts of them sandwiched between the respective peripheral portions of the front substrate and the rear substrate. Thus, the melted sealing layers are sandwiched between the front substrate 11 and the sidewall 18. If the melted indium is urged to become locally rugged owing to variation in the cross-sectional areas of the sealing layers 21a and 21b along the peripheries of the substrates and the gravity, therefore, the melted indium that is motivated to cohere excessively is pushed back to coarse portions, since a space between the front substrate 11 and the sidewall 18 is restricted. In consequence, the sealing layers can be prevented from becoming rugged. Therefore, the cross-sectional areas of the melted sealing layers are uniform throughout the peripheries of the front substrate 11 and sidewall 18, so that the sealing layers can be heated uniformly throughout their peripheries as they are joined together. Accordingly, disconnection of the sealing layers by local heating, cracking of the substrates, etc., can be prevented to ensure stable joining. Thus, an FED can be provided that can be manufactured at low cost and ensure high reliability and formation of satisfactory images.

According to the manufacturing method described above, current can be supplied with each electrode 30 in electrical contact with both the sealing layer 21b on the side of the front substrate 11 and the sealing layer 21a on the side of the rear substrate 12 at one time, that is, equivalently in contact with both the sealing layers. Thus, the individual sealing layers can be supplied with currents of substantially equal magnitudes. In consequence, the sealing layers on the front substrate 11 and the rear substrate 12 can be equally heat-melted and joined together with stability.

The following is a description of a method of manufacturing an FED according to a ninth embodiment of this invention.

In the foregoing eighth embodiment, the electrodes 30 are sandwiched between the upper and lower sealing layers 21a and 21b and brought into electrical contact with both the sealing layers at one time. According to the ninth embodiment, sealing layers 21a and 21b are partially welded in advance at portions for contact with electrodes 30, and the electrodes 30 are in contact with the welded portions.

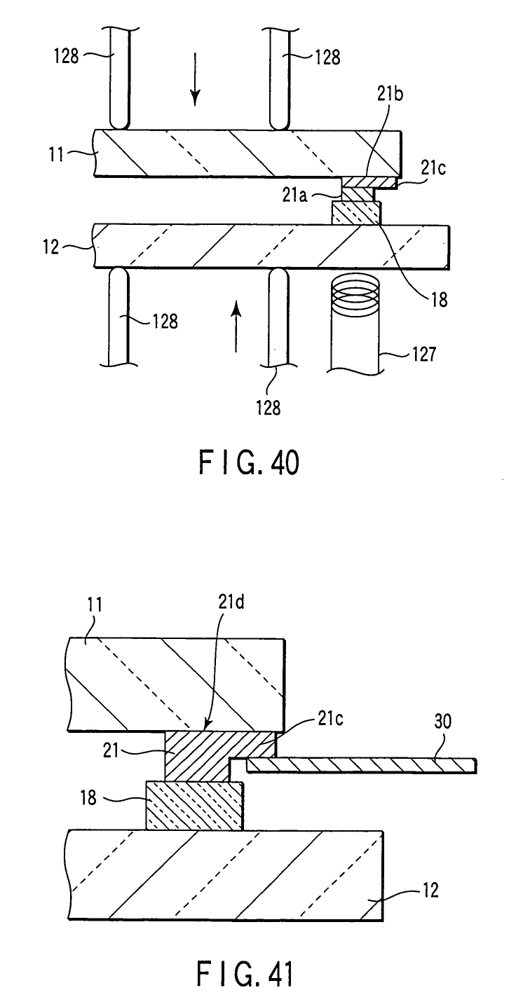

More specifically, a front substrate 11 and a rear substrate 12 that are delivered to the assembly chamber 105 of the vacuum processor are held by a plurality of support pins 128, as shown in FIG. 40, and pressurized toward each other. Thereupon, the sealing layer 21b on the front substrate 11 and the sealing layer 21a on a sidewall 18 come into contact with each other. At the portions for contact with the electrodes 30, the sealing layer 21b on the front substrate 11 has an extended portion 21c that extends outward beyond other portions, for example. The extended portion 21c is located near each of two opposite corner portions of the front substrate 11, for example.

Subsequently, an induction heating coil 127 is located under a corner portion of the rear substrate 12, for example, in a position corresponding to each extended portion 21c. The induction heating coil 127 subjects the sealing layers 21a and 21b to local high-frequency heating, thereby partially welding the sealing layers together. Thereupon, welded portions 21d are formed individually at two diagonally opposite corner portions.

Thereafter, the electrodes 30 of copper, having a thickness of about 0.2 mm each, are inserted between the front substrate 11 and the rear substrate 12, and are brought individually into contact with the extended portions 21c at the welded portions 21d. In this state, current from the power source is supplied through the paired electrodes 30 to the sealing layers 21a and 21b. Thus, indium is heated and melted so that the front substrate 11 and the sidewall 18 are airtightly joined together with the sealing layers 21a and 21b.

When the current supply is stopped, thereafter, the melted indium solidifies, whereupon an envelope 10 is formed. The envelope formed in this manner is cooled to normal temperature in the cooling chamber and taken out of the unloading chamber. In this process, the vacuum envelope is completed.

Other configurations are the same as those of the foregoing embodiments, so that like reference numerals are used to designate like portions, and a detailed description of those portions is omitted.

According to the ninth embodiment arranged in this manner, the opposite indiums are previously welded together in the positions for contact with the electrodes 30 before the current supply. By doing this, currents of substantially equal magnitudes can be supplied split to the sealing layer 21b on the side of the front substrate 11 and the sealing layer 21a on the side of the sidewall 18. Thus, the two sealing layers 21a and 21b can be heat-melted equally. Since the front substrate 11 and the rear substrate 12 are pressurized toward each other as the sealing layers are energized, moreover, change of the cross-sectional areas of the melted sealing layers can be restrained, so that the whole sealing layers can be equally heated to a higher temperature, as in the eighth embodiment. In this manner, the front substrate 11 and the rear substrate 12 can be stably joined together to obtain an FED with improved reliability.

In the eighth and ninth embodiments, the substrates may be previously fitted with the electrodes, for example, before they are put into the vacuum processor, and the shape and material of the electrodes are not limited to those of the foregoing embodiments. Although the sealing material is provided on both the front substrate and the sidewall during the sealing operation, moreover, the sealing material may alternatively be provided on the front substrate and/or the sidewall during the sealing operation.

The following is a description of an FED according to a tenth embodiment of this invention and its manufacturing method.

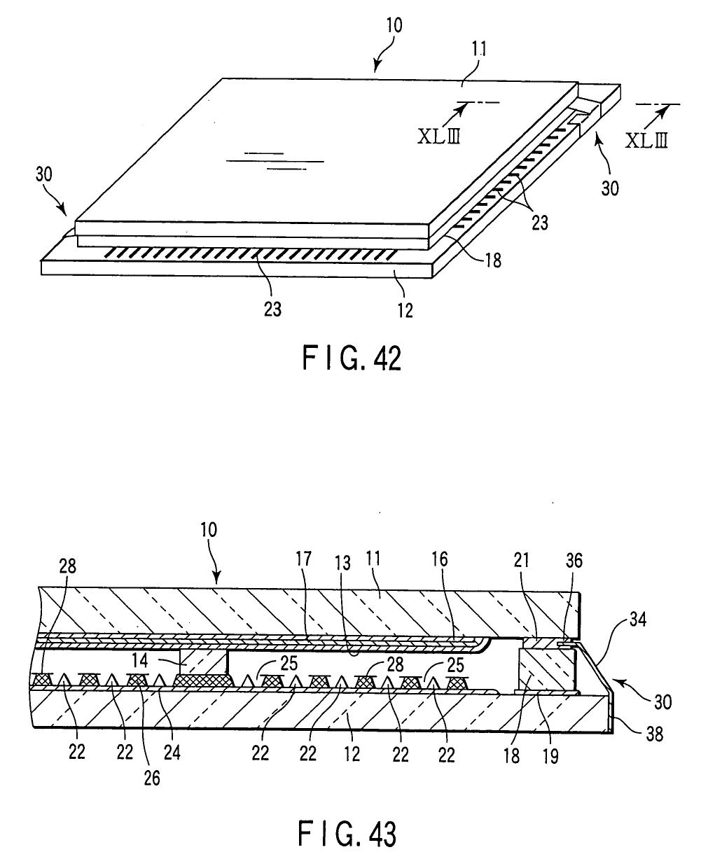

As shown in FIGS. 42 and 43, the FED is provided with a vacuum envelope 10 and a plurality of, e.g., a pair of, electrodes 30 attached to the vacuum envelope. The vacuum envelope 10 comprises a front substrate 11 and a rear substrate 12, which are formed of a rectangular glass sheet each. These substrates 11 and 12 have their respective peripheral edge portions joined together by a sidewall 18 in the form of a rectangular frame. A phosphor screen 16, a metal back 17, and a getter film 13 are formed on the inner surface of the front substrate 11. A large number of electron emitting elements 22 that excite phosphor layers of the phosphor screen 16 are arranged on the inner surface of the rear substrate 12. Further, a large number of wires 23 that supplies potential to the electron emitting elements 22 are arranged in a matrix on the inner surface of the rear substrate 12, and their respective end portions are drawn out to the peripheral edge portion of the vacuum envelope 10.

The paired electrodes 30 are attached to the envelope 10 in a manner such that they conduct electrically to a sealing layer 21. These electrodes 30 are used as electrodes for energizing the sealing layer 21. As shown in FIG. 44, each electrode 30 is formed by bending, for example, a copper sheet of 0.2-mm thickness as an electrically conductive member. More specifically, the electrode 30 is bent to have a substantially U-shaped profile. It integrally comprises an attachment portion 32, a body portion 34 that extends from the attachment portion and serves as a passage through which current flows to the sealing layer, a contact portion 36 situated on an extended end of the body portion and capable of touching the sealing layer, and a flat conduction portion 38 formed of the respective back parts of the attachment portion and the body portion.

The attachment portion 32 integrally comprises a nipping portion that is bent in the shape of a clip, and can be attached to the front substrate 11 or the rear substrate 12 so as to nip the peripheral edge portion of the substrate. The contact portion 36 is formed having a horizontal extension length L of 2 mm or more. Further, the body portion 34 is in the form of a belt, which extends inclining diagonally upward from the attachment portion 32. Thus, the contact portion 36 is situated higher than the attachment portion 32 and the body portion 34 contact portion 36 with respect to the vertical direction.

As shown in FIGS. 42, 43 and 44, each electrode 30 is attached to the vacuum envelope 10 with the peripheral edge portion of, for example, the rear substrate 12 elastically nipped by, for example, the attachment portion 32 of the vacuum envelope 10. The contact portion 36 of each electrode 30 touches and electrically conducts to the sealing layer 21. The body portion 34 extends from the contact portion 36 to the outside of the vacuum envelope 10, and the conduction portion 38 is opposed to a side face of the rear substrate 12 and exposed on the outer surface of the vacuum envelope 10. These paired electrodes 30 are provided individually at two diagonally spaced corner portions of the vacuum envelope 10 and located symmetrically with respect to the sealing layer 21.

Other configurations of the FED described above are the same as those of the foregoing first embodiment, so that like reference numerals are used to designate like portions, and a detailed description of those portions is omitted.

The following is a detailed description of a method of manufacturing the FED according to the tenth embodiment. The following description is focused on those different portions which are not proper to the manufacturing method according to the first embodiment.

First, as in the first embodiment, the front substrate 11 having the phosphor screen 16 and the metal back 17 formed thereon and the rear substrate 12 having the electron emitting elements 22 thereon are prepared. Subsequently, the sidewall 18 and support members 14 are sealed onto the inner surface of the rear substrate 12 with low-melting glass 19 in the atmosphere. Thereafter, a sealing layer 21a is formed by spreading indium to a given width and thickness over the entire periphery of a seal surface of the sidewall 18. A sealing layer 21b is formed by spreading indium in the shape of a rectangular frame with a given width and thickness over a seal surface of the front substrate 11 that faces the sidewall.

Subsequently, the paired electrodes 30 are mounted on the rear substrate 12 to which the sidewall 18 is joined, as shown in FIG. 45. As this is done, each electrode 30 is mounted with the contact portion 36 facing the sealing layer 21a across a gap without touching the sealing layer. The electrodes 30 are expected to be a pair of electrodes, positive and negative, on the substrate, and the respective lengths of conduction paths for the sealing layers 21a and 21b that are energized in parallel between the paired electrodes should preferably be made equal. To attain this, the paired electrodes 30 are attached individually to the two corner portions that face each other in the diagonal direction of the rear substrate 12, and the respective lengths of the sealing layers 21a and 21b that are situated between the electrodes are set to be substantially equal on the opposite sides of each electrode.

After the electrodes 30 are mounted, the rear substrate 12 and the front substrate 11 are opposed to each other at a given space, and in this state, put into the vacuum processor shown in FIG. 9. The front substrate 11 and the rear substrate 12 are fed into the baking/electron beam cleaning chamber 102 through the loading chamber 101. In the baking/electron beam cleaning chamber 102, the individual members are heated to a temperature of 300° C., and the surface-adsorbed gas is released from each substrate. At the same time, electron beams emitted from the electron beam generator are applied to a phosphor screen surface of the front substrate 11 and electron emitting element surfaces of the rear substrate 12, whereby the phosphor screen surface and the electron emitting element surfaces are individually entirely cleaned with the electron beams.

The sealing layers 21a and 21b are temporarily melted by heating to become fluid in a baking process. However, the contact portion 36 of each electrode 30 faces the sealing layers 21a and 21b across gaps without touching them. Therefore, the melted indium can be restrained from flowing out of the rear substrate 12 through the electrodes 30.

After the front substrate 11 and the rear substrate 12, having undergone the baking and electron beam cleaning, are fed into the cooling chamber 103 and cooled to a temperature of about 120° C., they are delivered to the vapor deposition chamber 104 for getter film. In this vapor deposition chamber 104, a Ba film is formed as a getter film 27 on the outside of the metal back 17 by vapor deposition. The surface of the Ba film can be prevented from being contaminated by oxygen, carbon, etc., so that it can maintain its active state.

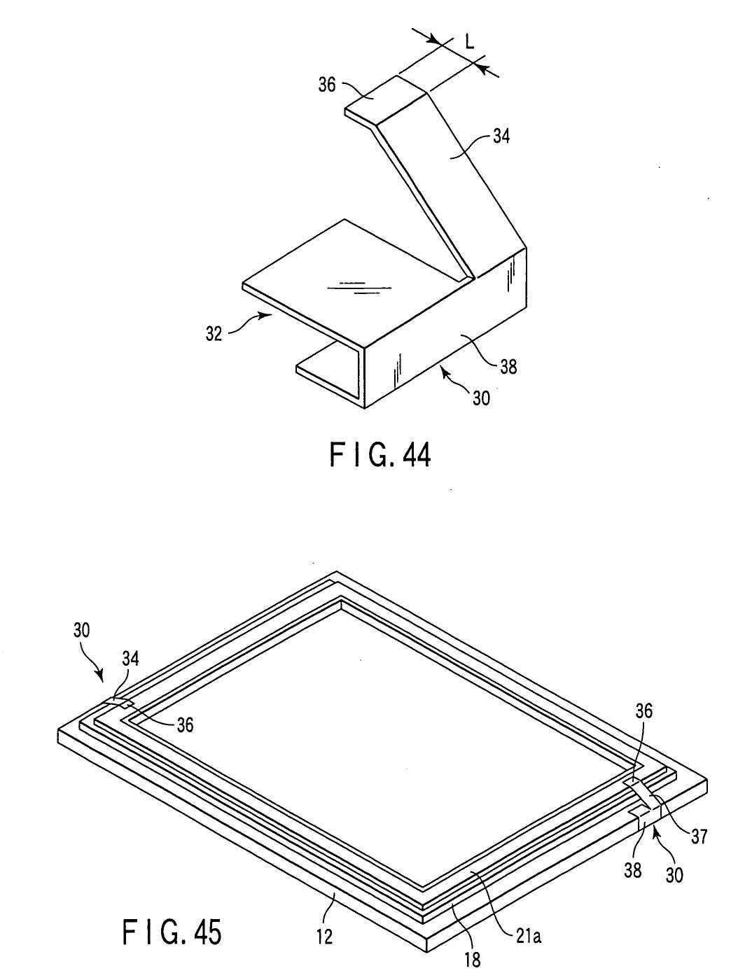

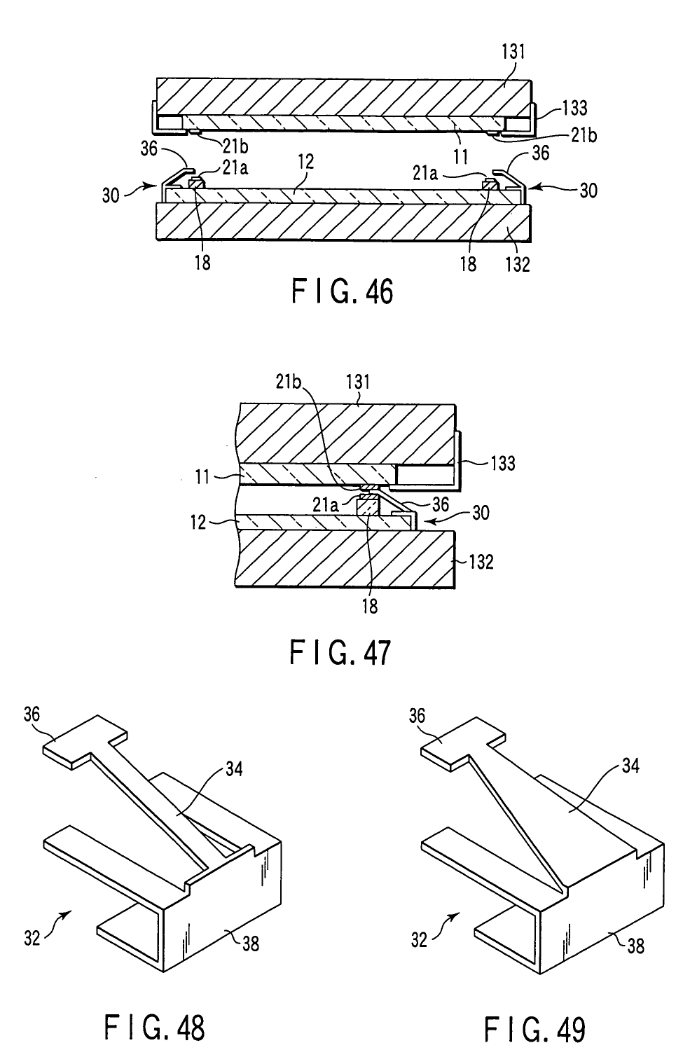

Subsequently, the front substrate 11 and the rear substrate 12 are fed into the assembly chamber 105. In this assembly chamber 105, as shown in FIG. 46, the front substrate 11 and the rear substrate 12 are held opposite to each other by hotplates 131 and 132, respectively, in the assembly chamber. The front substrate 11 is fixed to the upper hotplate 131 with a fixing jig 133 lest it fall.

Thereafter, the front substrate 11 and the rear substrate 12 are kept at about 120° C. as they are moved toward each other and pressurized under a given pressure. The substrates may be moved either by a method in which both the front substrate 11 and the rear substrate 12 are moved toward each other or by a method in which either the front substrate or the rear substrate is moved so that they approach each other.

By pressurization under a given pressure, as shown in FIG. 47, the sealing layer 21b on the side of the front substrate 11 and the sealing layer 21a on the side of the rear substrate 12 are brought into contact with each other. Besides, the contact portion 36 of each electrode 30 is sandwiched between the sealing layers 21a and 21b so that each electrode 30 is connected electrically to the sealing layers 21a and 21b. In this case, the contact portion 36 is formed having a horizontal length of 2 mm or more, so that it can be brought stably into contact with the sealing layers 21a and 21b. If indium is previously spread over the contact portion 36 of the electrode 30, the sealing material can enjoy better contact and energization.

After the power source 120 is connected electrically to the paired electrodes 30 in this state, as shown in FIG. 10, a dc current of, e.g., 140 A is supplied to each of the sealing layer 21a on the side of the sidewall 18 and the sealing layer 21b on the side of the front substrate 11 in a constant-current mode. Thereupon, the sealing layers 21a and 21b are heated so that the indium is melted. As this is done, electrical conduction between the power source 120 and the electrodes 30 and between the electrodes and the sealing layers 21a and 21b can be secured by bringing connector terminals 40 connected to the power source into contact with the conduction portions 38 of the electrodes 30. Since each electrode 30 is equivalently in contact with the sealing layers 21a and 21b, moreover, stable electrical conduction can be ensured, so that the individual sealing layers can be supplied with currents of substantially equal magnitudes and equally heat-melted.

By melting the indium, the sealing layers 21a and 21b are fused together to form the sealing layer 21, and the peripheral edge portion of the front substrate 11 and the sidewall 18 are sealed together with the resulting sealing layer. The front substrate 11, sidewall 18, and rear substrate 12, sealed together in the processes described above, are cooled to normal temperature in the cooling chamber 106 and taken out of the unloading chamber 107. Thus, the vacuum envelope of the FED is completed.

If necessary, the paired electrodes 30 may be cut off after the vacuum envelope 10 is completed.

According to the FED constructed in this manner and its manufacturing method, steady current can be supplied to the sealing layer 21 through the electrodes 30 attached to the rear substrate during electrical heating. During sealing operation, therefore, the electrically conductive low-melting sealing material that forms the sealing layer can be melted stably and securely in a predetermined energization time. In consequence, quick and secure sealing can be carried out without causing the sealing layer 21 to crack, for example.

The surface-adsorbed gas can be satisfactorily discharged by combining baking and electron beam cleaning, and a getter film with excellent adsorption capacity can be obtained. Since the front substrate and the rear substrate are sealed and joined together by electrically heating the indium, moreover, they need not be entirely heated, and the sealing operation can be carried out stably in a short time with the whole substrates kept at low temperature. At the same time, deterioration of the getter film, cracking of the substrates during the sealing process, or other failure can be avoided.

In a state before sealing, the contact portions 36 of the electrodes 30 face the sealing layers across gaps without touching them. If the sealing material is melted in the baking process or the like, therefore, the melted sealing material can be prevented from flowing out through the electrodes. Accordingly, the thickness of each sealing layer can be kept uniform throughout its periphery, and shorting of the wires or the like that is attributable to the outflow of the sealing material can be prevented. Thus, an FED can be obtained at low cost that ensures outstanding mass-productivity and, at the same time, formation of stable satisfactory images.

In each electrode 30 of the tenth embodiment described above, the contact portion 36 and the body portion 34 formed in the shape of belts that have the same width. As shown in FIG. 48, the body portion 34 may be formed narrower than the contact portion 36. In this case, the body portion 34 is in the form of a belt that has a uniform width throughout its length. As shown in FIG. 49, moreover, that part of the body portion 34 which connects with the contact portion 36 may be formed narrow than the contact portion. In this case, the width of the body portion gradually increases from the contact portion toward the attachment portion 32.

Thus, with use of the electrodes 30 in which the width of the body portion 34, especially the width of at least that part of the body portion which connects with the contact portion 36, is narrower than the width of the contact portion, heat from the body portion 34 can be quickly transmitted to the sealing layers through the contact portion 36 during electrical heating operation. Accordingly, the sealing layers can be energized more stably, so that the whole sealing layers can be heated substantially equally, and joining can be carried out quickly and securely.

Although the width of the body portion 34 is narrowed in this case, the body portion may be bored or notched for control, or the thickness of the body portion may be reduced for control. Further, the body portion may be formed of a material that is different from the material of any other portion. In this case, heat release may be controlled by superposing material sheets.

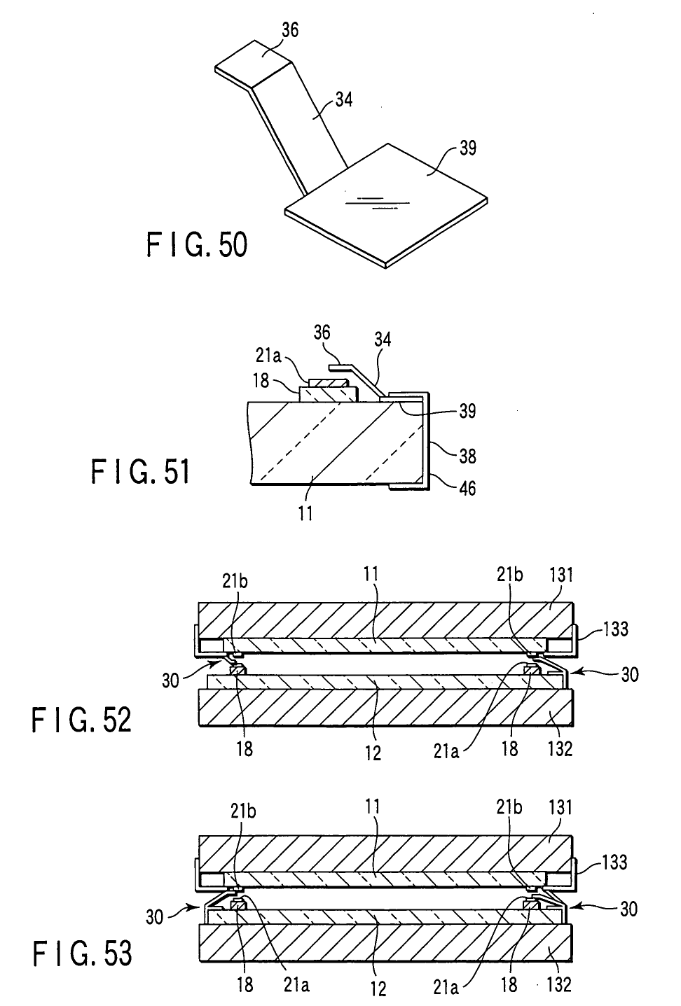

In the tenth embodiment described above, the attachment portion of each electrode 30 is provided integrally with a clip-shaped nipping portion. Alternatively, however, a separate clip 46 may be provided as a nipping portion, as shown in FIGS. 50 and 51. More specifically, each electrode 30 has the contact portion 36, the body portion 34, and a flat base portion 39, and is integrally formed by bending a material sheet. Further, the attachment portion of the electrode 30 is composed of the base portion 39 and the separate clip 46. Furthermore, the electrode 30 is attached to the rear substrate 12 with the respective peripheral edge portions of the base portion 39 and the substrate, or the peripheral edge portion of the rear substrate 12 in this case, nipped by the clip 46.

Other configurations of the modifications shown in FIGS. 48 to 51 are the same as those of the foregoing embodiment, so that like reference numerals are used to designate like portions, and a detailed description of those portions is omitted. Functions and effects similar to those of the foregoing embodiment can be also obtained with these embodiments.

The tenth embodiment is configured so that the paired electrodes are attached to the opposite diagonal portions of the rear substrate and that the sealing layers are energized with the substrates pressurized. Alternatively, however, a pair of electrodes may be also attached to the front substrate so that the sealing layers can be energized and heat-melted independently of the rear substrate side.

As shown in FIG. 52, in this case, the front substrate 11 and the rear substrate 12 that are fed into the assembly chamber are fixed on the hotplates 131 and 132, respectively, and located opposite to each other, and thereafter, moved toward each other. The contact portion of the electrode 30 that is attached to the rear substrate 12 comes into electrical contact with the sealing layer 21b on the side of the front substrate 11, while the contact portion of the electrode 30 that is attached to the front substrate 11 electrically touches the sealing layer 21a on the side of the rear substrate 12. As this is done, the sealing layer 21b on the side of the front substrate 11 and the sealing layer 21a on the side of the rear substrate 12 are kept untouched by each other.

When current is applied to the sealing layers 21a and 21b through the electrodes 30 in this state, the sealing layer 21a and the sealing layer 21b are melted independently of each other. After the melting, the current supply is stopped, and the substrates 11 and 12 are further moved toward each other and pressurized. By doing this, the sealing layers 21a and 21b are fused together to form the sealing layer 21, and the peripheral edge portion of the front substrate 11 and the sidewall 18 are sealed together with the sealing layer 21.

Alternatively, two pairs of electrodes may be attached to one substrate. In this case, one pair of electrodes are used to energize the sealing layer 21a on the side of the rear substrate 12, and the other pair of electrodes to energize the sealing layer 21b on the side of the front substrate 11.

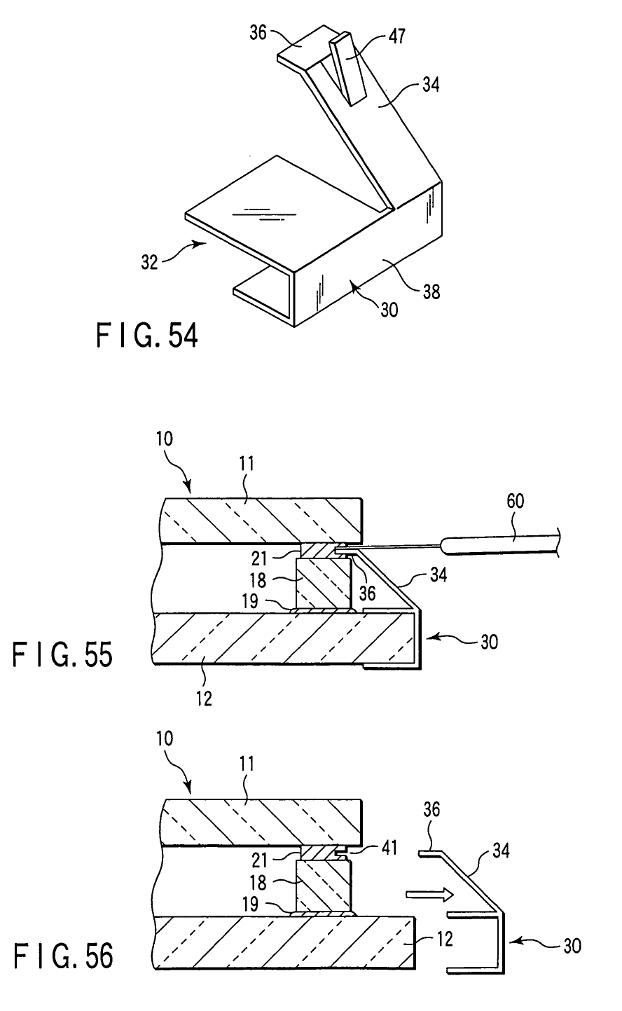

In this case, two pairs of electrodes 30 are attached to the rear substrate 12, as shown in FIG. 53. The front substrate 11 and the rear substrate 12 that are fed into the assembly chamber are fixed on the hotplates 131 and 132, respectively, and located opposite to each other, and thereafter, moved toward each other. The respective contact portions 36 of one pair of electrodes, among the electrodes that are attached to the rear substrate 12, are brought into electrical contact with the sealing layer 21b on the side of the front substrate 11. In each electrode 30 of the other pair, as shown in FIG. 54, a projection 47 is formed on the body portion 34 of the electrode. When the front substrate 11 and the rear substrate 12 are moved toward each other, the projection 47 engages the peripheral edge portion of the front substrate 11, while the contact portion 36 of the electrode moves toward the sealing layer 21a on the side of the rear substrate 12 and comes into electrical contact with the sealing layer 21a. As this is done, the sealing layer 21b on the side of the front substrate 11 and the sealing layer 21a on the side of the rear substrate 12 are kept untouched by each other.

When current is applied to the sealing layers 21a and 21b through the electrodes 30 in this state, the sealing layers 21a and 21b are heated to be melted independently of each other. After the melting, the current supply is stopped, and the front substrate 11 and the rear substrate 12 are further moved toward each other and pressurized. By doing this, the sealing layers 21a and 21b are fused together to form the sealing layer 21, and the peripheral edge portion of the front substrate 11 and the sidewall 18 are sealed together with the sealing layer.

Other configurations of the modifications shown in FIGS. 52, 53 and 54 are the same as those of the foregoing tenth embodiment, so that like reference numerals are used to designate like portions, and a detailed description of those portions is omitted. Functions and effects similar to those of the foregoing embodiment can be also obtained with these modifications.

In each of the foregoing embodiments, on the other hand, the electrodes may be removed from the vacuum envelope of the FED after sealing the vacuum envelope is finished. A manufacturing method according to an eleventh embodiment of this invention is configured so that electrodes 30 are cut from a vacuum envelope after the sealing. In the tenth embodiment, for example, the envelope 10 is taken out of the unloading chamber 107 of the vacuum processor after the sealing. The electrodes 30 are kept firmly joined to a sealing layer 21 as they are left in the envelope 10. Therefore, these electrodes 30 are removed from the envelope 10 in the following processes.

First, the edge of an ultrasonic cutter 60 is inserted into an interface between each electrode 30 and the sealing layer 21, as shown in FIG. 55, and that part of the sealing layer 21 which is situated around a contact portion 36 of the electrode is removed by ultrasonic cutting. If the ultrasonic cutter 60 is used, frictional force between the edge and the sealing layer 21 is reduced by ultrasonic vibration, so that the sealing layer can be easily cut and removed without any substantial pressurization.

If that part of the sealing layer around the contact portion 36 of each electrode 30 is removed in this manner, the bonding force between the electrode and the sealing layer lessens. In this state, as shown in FIG. 56, an attachment portion 32 of the electrode 30 is chucked with a holding jig (not shown) and drawn out in the direction of the arrow. Thus, the electrodes 30 can be mechanically removed from the envelope 10 without damaging substrates or the sealing layer.

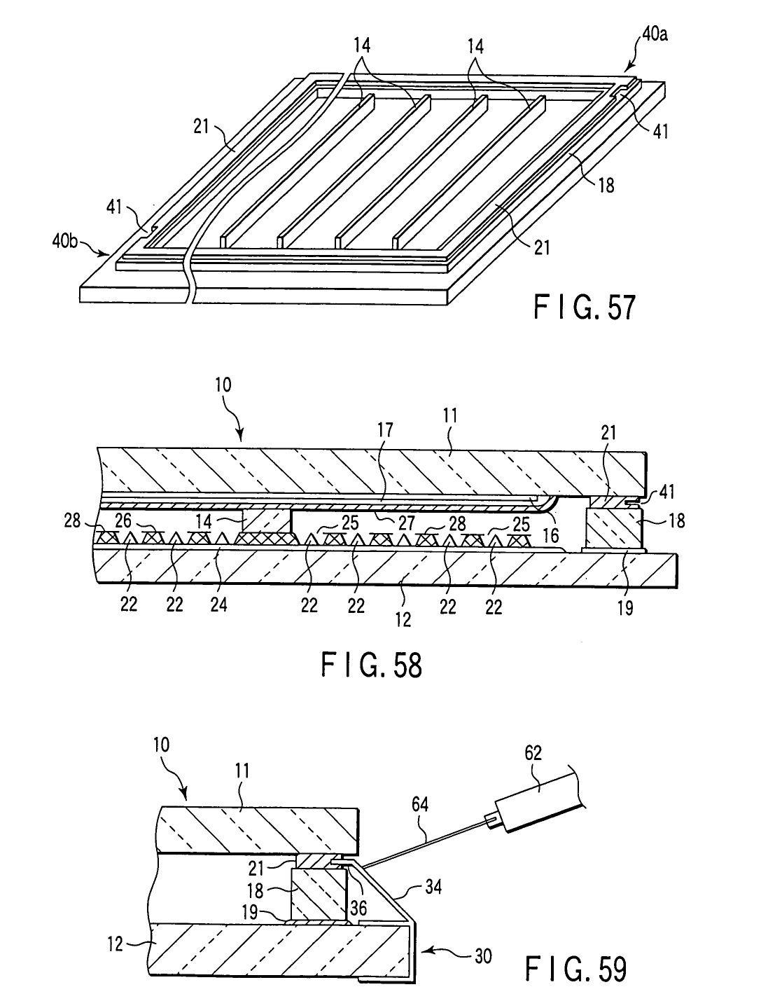

If the electrodes 30 are removed from the FED constructed in this manner, recesses 41 are left individually in those parts of the sealing layer 21 which correspond to traces of the location of the respective contact portions 36 of the electrodes. More specifically, as shown in FIGS. 57 and 58, the recesses 41, e.g., 5 mm wide and about 1 mm deep each, are formed individually in those two spots of the sealing layer 21 which are situated corresponding to two diagonally opposite corner portions 40a and 40b of the vacuum envelope 10, and individually open outward of the vacuum envelope. Thus, the sealing layer 21 is formed so that its width is partially narrowed at the corner portions 40a and 40b of the vacuum envelope 10.

Other configurations of the eleventh embodiment are the same as those of the foregoing tenth embodiment, so that like reference numerals are used to designate like portions, and a detailed description of those portions is omitted.

Functions and effects similar to those of the foregoing embodiments can be obtained with the manufacturing method and the FED according to the eleventh embodiment arranged in this manner. Such an advantage can be obtained that handling the envelope can be simplified by removing the electrodes that become unnecessary components for the FED after the sealing. The electrodes can be prevented from hindering operation for incorporating the FED as a monitor into a cabinet, for example. Such a problem can be eliminated that those parts of the electrodes which project from the substrates damage some other devices or an operator or that a load acts on the envelope through the electrodes, thereby breaking the envelope. Further, a transportation unit or the like need not be converted to be compatible with the electrodes, so that manufacturing costs can be lowered.

By using the ultrasonic cutter or the like for ultrasonic vibration cutting, the sealing material around the electrodes can be removed, so that the electrodes can be disengaged with ease.

Although the ultrasonic cutter is used to remove the electrodes 30 from the vacuum envelope 10 according to the eleventh embodiment described above, the electrodes may alternatively be removed by the following method. As shown in FIG. 59, an ultrasonic vibrator 64 that is connected to an ultrasonic source 62 is brought into contact with the electrode 30, whereupon the electrode 30 is subjected directly to ultrasonic vibration. In this case, the electrode 30 itself serves as the edge of the ultrasonic cutter and cuts the interface between the contact portion 36 of the electrode and the sealing layer 21 by ultrasonic vibration. Thus, the sealing material around the electrode 30 can be removed, so that the electrode can be disengaged with ease.

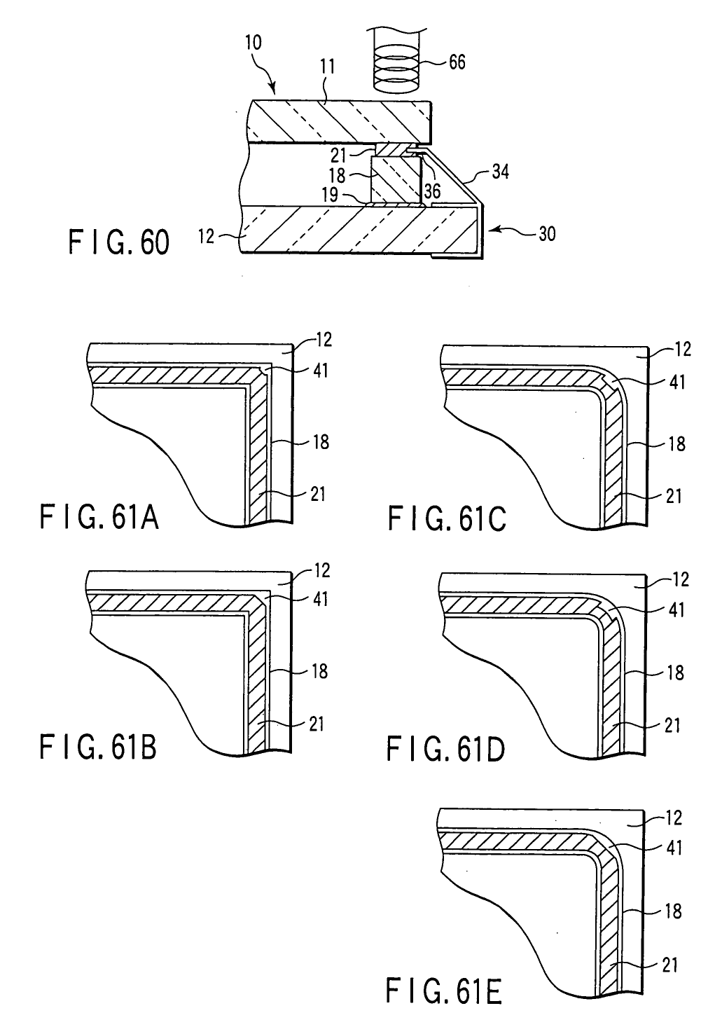

The electrode 30 may be drawn out from the sealing layer 21 with the bonding force between the electrode and the sealing layer reduced by partially heating and softening that region of the sealing layer which is situated near the contact portion 36 of the sealed electrode. To attain this, that part of the sealing layer 21 which is situated near the contact portion 36 of the electrode 30 is subjected to induction heating. After the sealing, more specifically, an induction heating coil 66 is located adjacent and opposite to a front substrate 11 of the vacuum envelope 10, for example, in the vicinity of the electrode 30, as shown in FIG. 60. By applying high frequencies to the induction heating coil 66, the sealing layer 21 is subjected to high-frequency heating through the front substrate 11, whereupon the sealing layer is softened partially.

In this case, the attachment portion 32 of the electrode 30 is previously chucked with the holding jig (not shown) and subjected to a small tensile force in the outward direction of the substrate. Thereupon, the bonding force between the electrode 30 and the sealing layer 21 weakens when the sealing layer 21 is softened, so that the electrode 30 can be drawn out. After the electrode 30 is drawn out, the induction heating coil 66 is de-energized and separated from the vacuum envelope 10. When this is done, the heated part of the sealing layer 21 is quickly cooled, whereupon the envelope 10 of the FED is completed.

In the embodiment shown in FIG. 60, the electrode 30 may be mechanically removed after that part of the sealing layer 21 near the contact portion 36 of the electrode is melted by induction heating. If the heating time is long, in this case, a wide region of the sealing layer 21 flows out inevitably, so that the airtight sealing of the envelope may possibly be broken. Preferably, therefore, the sealing layer should be heated in a short time of about 3 to 30 seconds. If the heating time is short, only that part of the contact portion 36 that is situated near the contact portion 36 is melts, so that the vacuum airtightness of the envelope 10 can be kept secured when the electrode 30 is removed.

Further, the region around the electrode may be heated by using a local heater or by any other method than induction heating.

Other configurations of the embodiments individually shown in FIGS. 59 and 60 are the same as those of the foregoing eleventh embodiment, so that like reference numerals are used to designate like portions, and a detailed description of those portions is omitted.

In the FED, moreover, the sealing layer 21 may be formed having any of recesses 41 shown in FIGS. 61A to 61E, depending on the positions in which the electrodes are located or the shapes of the electrodes. According to a modification shown in FIG. 61A, the respective corner portions of the sidewall 18 and the sealing layer 21 are right-angled, and each recess 41 is formed at a corner portion of the sealing layer and has a rectangular shape extending in the diagonal direction. According to a modification shown in FIG. 61B, the respective corner portions of the sidewall 18 and the sealing layer 21 are right-angled, and each recess 41 is formed by chamfering a corner portion of the sealing layer and extends in the diagonal direction.

According to a modification shown in FIG. 61C, the respective corner portions of the sidewall 18 and the sealing layer 21 are arcuate, and each recess 41 is formed at a corner portion of the sealing layer and has a rectangular shape extending in the diagonal direction. According to a modification shown in FIG. 61D, the respective corner portions of the sidewall 18 and the sealing layer 21 are arcuate, and the bottom portion of each recess 41 is formed at a corner portion of the sealing layer and has an arcuate shape convexed in the diagonal direction. According to a modification shown in FIG. 61E, moreover, the respective corner portions of the sidewall 18 and the sealing layer 21 are arcuate, and each recess 41 is formed by chamfering a corner portion of the sealing layer and extends in the diagonal direction.

Further, each recess 41 may have any other shape than the aforesaid ones, depending on the shape of the electrodes used. Furthermore, each electrode 30 may be located in, for example, the central part of a long side or a short side of the envelope without being restricted to a corner portion provided that the respective lengths of conduction paths of the sealing layer 21 are equal. In this case, each recess 41 is formed in the central part of a long side or a short side of the sealing layer 21 corresponding to the location of the electrode 30. The position and shape of each recess 41 may be set optionally.

In performing the sealing operation in the aforementioned assembly chamber 105, the sealing layers 21a and 21b that are provided on the front substrate 11 and the rear substrate 12 may be separately energized so that the two substrates can be pressurized toward each other under a desired to be sealed together after the sealing material is melted. In this case, the two substrates require use of two pairs of or four electrodes 30. These electrodes are attached individually to the four corner portions of the rear substrate 12, for example. One pair of electrodes are used to energize the sealing layer 21a on the rear substrate 12, and the other pair of electrodes to energize the sealing layer 21b on the front substrate 11. After the sealed electrodes are removed, therefore, the four recesses 41 are formed in the sealing layer 21 of the vacuum envelope 10.

These recesses are not limited to two or four in number for the aforesaid cases, and may be in any desired number depending on the number of electrodes used. If four electrodes each having a forked contact portion are used for electrical sealing, for example, eight recesses are formed.

Although the entire electrodes are removed from the vacuum envelope according to the eleventh embodiment described above, the electrodes may alternatively be removed with some odds left. According to a manufacturing method of a twelfth embodiment of this invention, each electrode 30 is cut in the middle of its body portion, and all of its portions except a contact portion 36 are removed from an envelope.

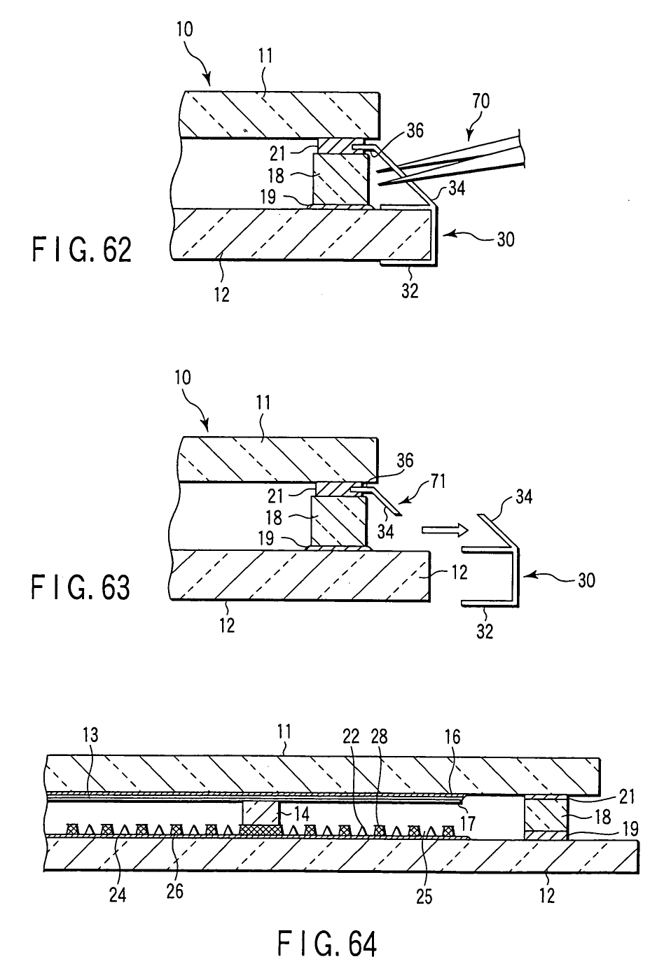

More specifically, a front substrate 11, sidewall 18, and rear substrate 12, which are sealed together in processes similar to those of the foregoing tenth embodiment, for example, are fed into the cooling chamber 106 of the vacuum processor and cooled to normal temperature. In this state, the contact portion 36 of each electrode 30 is kept firmly joined to a sealing layer 21. As shown in FIG. 62, the cooling chamber 106 is provided with an automated cutter 70. The automated cutter 70 is extended so as to nip a body portion 34 of the electrode 30, whereupon that part of the body portion 34 near the contact portion 36 is cut by the automated cutter.

Subsequently, as shown in FIG. 63, an attachment portion 32 of the cut electrode 30 is chucked with the holding jig (not shown) and drawn out in the direction of the arrow to be removed from the rear substrate 12. Thereupon, all other portions of the electrode 30 including the attachment portion 32 are disengaged from the envelope 10 with the contact portion 36 of the electrode and a part of the body portion 34 left on the side of the envelope. Since the other parts of the electrode 30 than the contact portion 36 are configured only elastically to nip the rear substrate 12, they can be easily removed without damaging the substrates or the sealing layer 21. After the tip portion of the electrode 30 is cut, the envelope 10 is fed into the unloading chamber 107 and taken out of the unloading chamber 107. Thus, the vacuum envelope 10 of an FED is completed.

When most of each electrode 30 is removed from the FED constructed in this manner, only a conductor piece 71 that includes the contact portion 36 of the electrode 30 and a part of the body portion 34 remains at each of two corner portions of the vacuum envelope 10.

Other configurations of the twelfth embodiment are the same as those of the foregoing tenth embodiment, so that like reference numerals are used to designate like portions, and a detailed description of those portions is omitted.

Functions and effects similar to those of the foregoing embodiments can be obtained with the manufacturing method and the FED according to the eleventh embodiment arranged in this manner. When most of each electrode, which is an unnecessary component for the sealed FED, is removed, moreover, the electrode tip portions remain at the corner portions of the envelope. Since regions for the odds are restricted to very narrow ranges, however, such an advantage can be obtained that handling the envelope is simple. The electrodes can be prevented from hindering operation for incorporating the FED as a monitor into a cabinet, for example. Such a problem can be eliminated that those parts of the electrodes which project from the substrates damage some other devices or an operator or that a load acts on the envelope through the electrodes, thereby breaking the envelope. Further, a transportation unit or the like need not be converted to be compatible with the electrodes, so that manufacturing costs can be lowered. By disengaging the electrodes 30 from the vacuum envelope after they are cut, the electrodes can be easily removed without damaging the sealing layer or the substrates.

Although the electrodes are cut and removed in the cooling chamber of the vacuum processor according to the twelfth embodiment described above, cut parts of the electrodes may alternatively be removed manually from the rear substrate 12 after cutting the electrodes in the cooling chamber and taking out envelope through the unloading chamber.

Further, the electrodes are configured to be cut with the automated cutter that is attached to the cooling chamber of the vacuum processor. Alternatively, however, the electrodes may be cut by means of a device for electrode cut-off that is prepared separately from the vacuum processor. If the electrodes are thin and easily cuttable, an operator may use a cutter or the like to cut them manually.

In the embodiment described above, a pair of electrodes for energizing a sealing layer 21a on the side of the rear substrate and a pair of electrodes for energizing a sealing layer 21b on the side of the front substrate may be provided independently of each other so that the sealing layers can be energized with two pairs of or four electrodes. In this case, the completed FED is configured so that four conductor pieces 71 that are equivalent to electrode tip portions are left thereon. It is to be understood that the positions, shape, and number of electrodes are not limited to the foregoing embodiment.

The following is a description of a manufacturing method and a manufacturing apparatus for an FED according to a thirteenth embodiment of this invention. FIG. 64 shows the FED that is manufactured according to the present embodiment. Other configurations of the FED are the same as those of the FED described in connection with each of the foregoing embodiments, so that like reference numerals are used to designate like portions, and a detailed description of those portions is omitted.

In the method of manufacturing the FED according to the thirteenth embodiment, as in the methods of the foregoing embodiments, a front substrate 11 having a phosphor screen 16 and a metal back 17 formed thereon and a rear substrate 12 having electron emitting elements 22 thereon are prepared first.

A sidewall 18 and support members 14 are sealed onto the inner surface of the rear substrate 12 with low-melting glass in the atmosphere. Thereafter, a sealing layer 21a in the shape of a rectangular frame is formed by spreading indium to a given width and thickness over the entire periphery of a seal surface of the sidewall 18. A sealing layer 21b in the shape of a rectangular frame corresponding to the sealing layer 21a on the side of the sealing layer 21a is formed by spreading indium in the shape of a rectangular frame with a given width and thickness over a seal surface of the front substrate 11 that faces the sidewall.

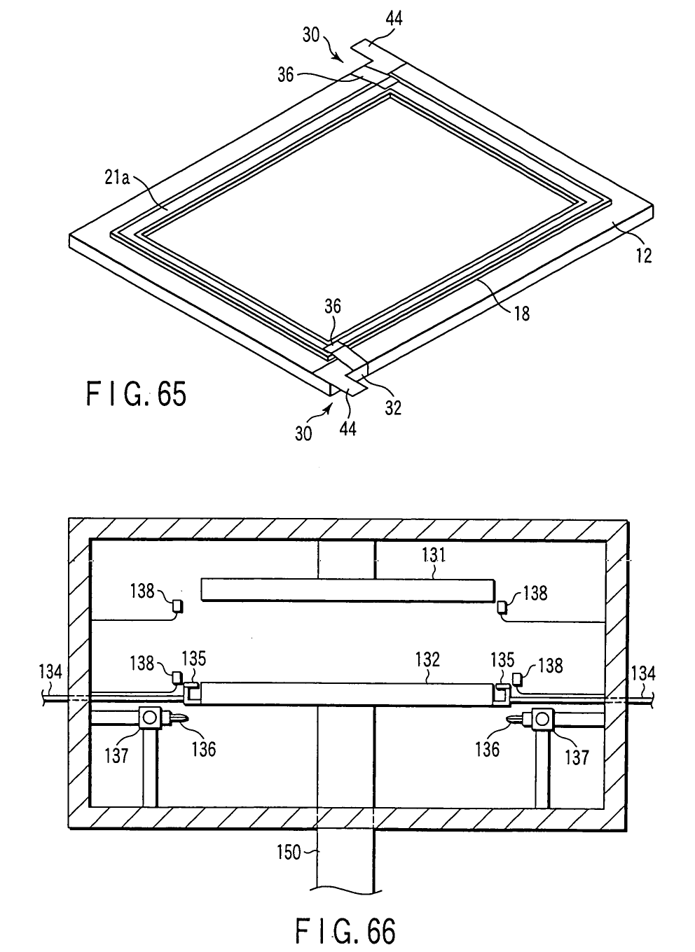

Subsequently, a pair of electrodes 30 for energization are mounted on the rear substrate 12 to which the sidewall 18 is joined, as shown in FIG. 65. Each electrode 30 is formed by bending, for example, a copper sheet of 0.2-mm thickness as an electrically conductive member. Each electrode 30 integrally comprises an attachment portion 32, a tongue portion 44, and a contact portion 36. The attachment portion 32 can be attached the rear substrate 12 so as to nip its peripheral edge portion. The tongue portion 44 is held by a holding jig, which will be mentioned later. The contact portion 36 can touch the sealing layer 21a. Each electrode 30 is attached to the rear substrate 12 with the peripheral edge portion of the rear substrate elastically nipped by the attachment portion 32. As this is done, the contact portion 36 of each electrode 30 is brought into contact with the sealing layer 21a on the sidewall 18, whereby the electrode is connected electrically to the sealing layer. The tongue portion 44 projects outward from the rear substrate 12.

After the paired electrodes 30 are attached to the rear substrate 12, the rear substrate 12 and the front substrate 11 are opposed to each other at a given space, and in this state, put into the vacuum processor. For example, the vacuum processor 100 shown in FIG. 9 is used in this case.

The aforesaid front and rear substrates 11 and 12 that are located at the given space are first put into the loading chamber 101. After the atmosphere in the loading chamber 101 is reduced to a vacuum, the substrates are delivered to the baking/electron beam cleaning chamber 102.

In the baking/electron beam cleaning chamber 102, the individual members are heated to a temperature of 300° C., and a gas that is adsorbed on the respective surfaces of the substrates sidewall is discharged. At the same time, electron beams emitted from the electron beam generator (not shown) that is attached to the baking/electron beam cleaning chamber 102 are applied to a phosphor screen surface of the front substrate 11 and electron emitting element surfaces of the rear substrate 12. In doing this, the electron beams are deflected for scanning by the deflector that is attached to the outside of the electron beam generator, whereby the phosphor screen surface and the electron emitting element surfaces are individually entirely cleaned with the electron beams.

The front substrate 11 and the rear substrate 12, thus subjected to the electron beam cleaning, are fed into the cooling chamber 103 and cooled to a temperature of about 120° C., and then delivered to the vapor deposition chamber 104 for getter film. In the vapor deposition chamber 104, a barium film is formed as a getter film on the outside of the phosphor layers by vapor deposition. The surface of the barium film can be prevented from being contaminated by oxygen, carbon, etc., so that it can maintain its active state.

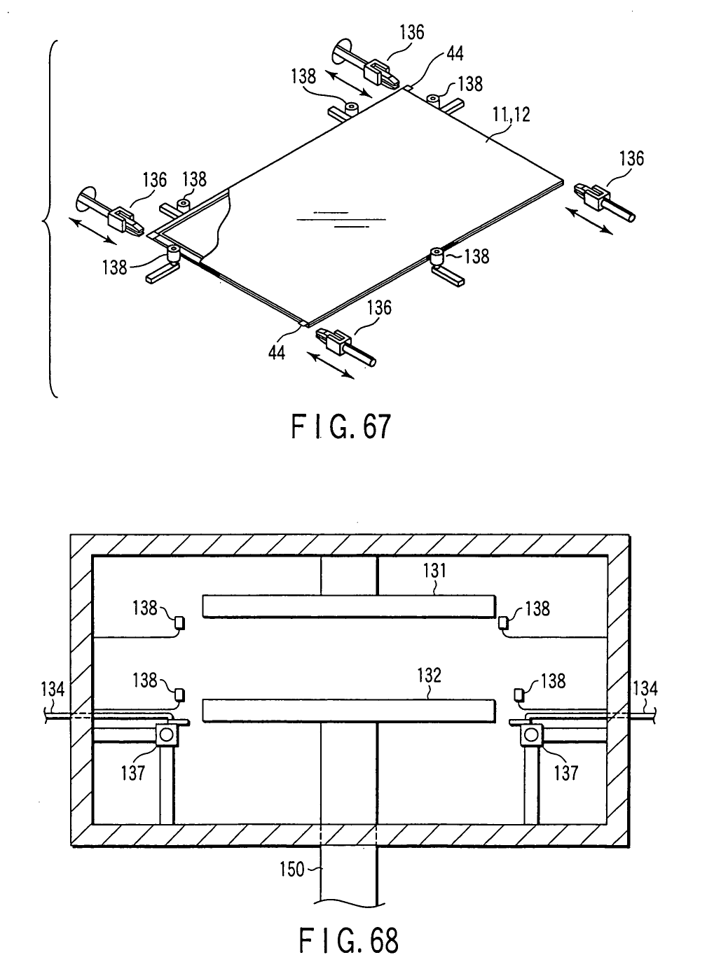

Subsequently, the front substrate 11 and the rear substrate 12 are fed into the assembly chamber 105. Set in the assembly chamber 105, as shown in FIGS. 66 and 67, are hotplates 131 and 132 for holding and heating the two substrates, a drive mechanism 150 for vertically driving the lower hotplate 132, wires 134 for energizing the sealing layers, and a pair of contact electrodes 135 that are individually in contact with the paired electrodes 30. Also set in the assembly chamber 105 are holders 136 for nipping and holding the paired electrodes 30, drive mechanisms 137 for driving the holders 136 vertically and in the in-plane direction, and a plurality of guide rollers 138 for moving the substrates in the in-plane direction, that is, in a direction parallel to the substrate surfaces. The contact electrodes 135 are attached to the lower hotplate 132. The wires 134 are connected to the power source 120 that is located outside the assembly chamber 105.

The front substrate 11 and the rear substrate 12 that are delivered to the assembly chamber 105 are first mechanically positioned with respect to their corresponding hotplates 131 and 132 by the guide rollers 138. After the front substrate 11 is positioned on a transportation jig, as this is done, it is attracted and fixed to the hotplate 131 by a conventional electrostatic attraction technique lest it fall. After the rear substrate 12 is set on the lower hotplate 132, it is positioned by the guide rollers 138. At the same time, the tongue portions 44 of the paired electrodes 30 are brought into contact with and connected electrically to their corresponding contact electrodes 135.

After the mutual positioning of the front substrate 11 and the rear substrate 12 is completed, the hotplate drive mechanism 150 moves the rear substrate 12 toward the front substrate 11 and pressurizes it under a given pressure. Thereupon, the respective contact portions 36 of the electrodes 30 are sandwiched between sealing layers 21b and 21a of the front substrate 11 and the rear substrate 12, and the electrodes are simultaneously brought into electrical contact with the sealing layers of the two substrates.

In this state, a dc current of 140 A is supplied from the power source 120 to the sealing layers 21a and 21b through the electrodes 30 in a constant-current mode. Thereupon, the indium is heated to be melted, and the front substrate 11 and the rear substrate 12 are airtightly sealed together. After the current supply is stopped, the drive mechanisms 137 move the holders 136 to the tongue portions 44 of the electrodes 30, as shown in FIG. 67, whereupon the tongue portions 44 are nipped by the holders. Thereafter, the drive mechanisms 137 move the holders 136 together with the electrodes 30 outward from the substrates along a direction parallel to the surface of the rear substrate 12. Thereupon, the electrodes 30 are separated from the melted indium and the rear substrate 12. Immediately after the current supply is stopped, the indium is melted, and the electrodes 30 can be easily separated from the sealing layers. If the sealing layer 21 is held as it is after the electrodes 30 are separated, the melted indium solidifies, whereupon an envelope 10 is formed. After the sealing, the envelope is delivered to the cooling chamber 106 to be cooled to normal temperature therein and taken out of the unloading chamber 107. In this process, the vacuum envelope 10 is completed.

Thus, according to the manufacturing method and the manufacturing apparatus for the FED of the thirteenth embodiment, the front substrate 11 and the rear substrate 12 are sealed and joined together in a vacuum atmosphere. Therefore, the surface-adsorbed gas can be satisfactorily discharged by combining baking and electron beam cleaning, and a getter film with excellent adsorption capacity can be obtained. Since the front substrate and the rear substrate are sealed and joined together by electrically heating the indium, they need not be entirely heated, and deterioration of the getter film, cracking of the substrates during the sealing process, or other failure can be avoided. At the same time, the sealing time can be shortened, so that the manufacturing method can enjoy outstanding mass-productivity. Since the electrodes are separated from the indium in the assembly chamber after the current supply, the electrodes never remain on the sealed FED. Therefore, the electrodes can be prevented from hindering operation for incorporating the FED as a monitor into a cabinet or breaking the envelope, for example. Thus, such an advantage can be obtained that handling the sealed envelope is simple.

In the thirteenth embodiment described above, the rear substrate 12 is put into the vacuum processor after it is fitted with to the paired electrodes 30. Alternatively, however, the manufacturing method and the manufacturing apparatus may be designed so that electrodes for energization are set in the vacuum processor and the substrate is put into the vacuum processor without being fitted with any electrodes.

As shown in FIG. 68, a manufacturing apparatus for an FED according to a fourteenth embodiment of this invention comprises hotplates 131 and 132 for fixing, holding, and heating two substrates, a drive mechanism 150 for vertically driving the lower hotplate 132, wires 134 and electrodes 145 for energizing the sealing layers, drive mechanisms 137 for driving the electrodes 145 in a direction parallel to the surfaces of the substrates and in a direction perpendicular to the substrate surfaces, and a plurality of guide rollers 138 for moving the substrates parallel to their surfaces and positioning them. The wires 134 for energization are connected to the power source 120 outside the assembly chamber. Other configurations of the manufacturing apparatus are the same as those of the foregoing thirteenth embodiment, so that like reference numerals are used to designate like portions, and a detailed description of those portions is omitted.

In the fourteenth embodiment, a front substrate 11 and a rear substrate 12 that are delivered to the assembly chamber 105 are first mechanically positioned with respect to their corresponding hotplates 131 and 132 by the guide rollers 138. After the front substrate 11 is positioned on a transportation jig, as this is done, it is attracted to the hotplate 131 by the conventional electrostatic attraction technique lest it fall.

Then, the electrode drive mechanisms 137 and the hotplate drive mechanism 150 move the electrodes 145 and the rear substrate 12 toward the front substrate 11 and pressurize them under a desired pressure. Thereupon, the electrodes 145 are sandwiched between sealing layers 21a and 21b of the two substrates, and the electrodes are simultaneously brought into electrical contact with the sealing layers of the two substrates.

In this state, a dc current of 140 A is supplied from the power source 120 to the sealing layers 21a and 21b through the electrodes 145 in a constant-current mode. Thereupon, indium is heated to be melted, and the front substrate 11 and the rear substrate 12 are airtightly sealed together. After the current supply is stopped, the electrode drive mechanisms 137 move the electrodes 145 outward from the substrates and separated from the melted indium. Immediately after the current supply is stopped, the indium is melted, so that the electrodes 145 can be easily separated from the indium. If this state is maintained for several minutes after the electrodes are separated, the melted indium solidifies, whereupon an envelope 10 is formed. After the sealing, the envelope 10 is delivered to the cooling chamber 106 to be cooled to normal temperature therein and taken out of the unloading chamber 107.

Other configurations of the fourteenth embodiment are the same as those of the thirteenth embodiment, and a description of like portions is omitted.

According to the arrangement described above, the electrodes 145 for energization are set in the assembly chamber 105 and disengaged from the sealing layers after energization. As in the thirteenth embodiment, therefore, no electrodes can remain on the sealed FED. Such a problem can be eliminated that the electrodes hinder operation for incorporating the FED as a monitor into a cabinet or the electrodes cause the envelope to break.

In the fourteenth embodiment, two pairs or four electrodes may be used so that a pair of electrodes can be brought into electrical contact with each of the sealing layers on the front substrate side and the rear substrate sides. In this case, the substrates are pressurized against each other after the electrodes are disengaged. It is to be understood that the positions, shape, and number of electrodes are not limited to the foregoing embodiment.

This invention is not limited to the various embodiments described above, and various modifications may be effected therein without departing from the scope of the invention. In each of the plurality of embodiments described above, the vacuum envelope is configured so that the sidewall is sandwiched between the front substrate and the rear substrate. Alternatively, however, the sidewall may be formed integrally with the front substrate or the rear substrate, or the sidewall may be joined to the front substrate and the rear substrate so as to cover them laterally. Further, the seal surface that is sealed by electrically heating the sealing material may be replaced by two surfaces between the front substrate and the sidewall and between the rear substrate and the sidewall.

According to the foregoing embodiments, the sealing material on the front substrate side and the sealing material on the rear substrate side are brought into contact with each other and electrically heated. Alternatively, however, the sealing materials may be joined together before they solidify after being electrically heated in a non-contact state. The configurations of the phosphor screen and the electron emitting elements are not limited to the embodiments of the present invention and may alternatively be any other configurations. Further, the sealing material is not limited to indium and may be any other material that is electrically conductive. In general, a metal can be used as the sealing material, since it undergoes a sudden resistance change as a phase change occurs. For example, a metal or alloy that contains In, Sn, Pb, Ga and/or Bi may be used as the sealing material.

Each FED described above is provided with one or two pairs of electrodes. Alternatively, however, each FED may be provided with at least one electrode that is previously attached to the envelope. In this case, electrical heating is carried out with other necessary electrodes attached to the envelope in the sealing process. Further, a plurality of electrodes may be located in any other positions than corner portions of the envelope provided that they are arranged so that conduction paths of the sealing layers between the electrodes have equal lengths or that they are arranged symmetrically with respect to the sealing layers.

In the embodiments described above, the sealing layers of indium are provided on both the rear substrate side and the front substrate side. Alternatively, however, the front substrate and the rear substrate may be sealed together with a sealing layer provided on only one of them.

The external shape of the vacuum envelope and the construction of the support members are not limited to the foregoing embodiments. A matrix-shaped light absorbing layer and phosphor layers may be formed so that columnar support members with a cruciform cross section are positioned with respect to the light absorbing layer and sealed. The electron emitting elements used may be formed of pn cold cathode elements or surface-conduction electron emitting elements. Although the processes for joining the substrates in a vacuum atmosphere have been described in connection with the foregoing embodiments, the joining may be also carried out in any other atmospheric environment.

This invention is not limited to an FED and may be also applied to any other image display device, such as an SED or PDP, or an image display device of which the envelope is kept at a high vacuum inside.

1. An image display device comprising:
an envelope having a front substrate and a rear substrate opposed to the front substrate, respective peripheral edge portions of the front substrate and the rear substrate being sealed together with a sealing layer which contains an electrically conductive sealing material; and
an electrode member which is attached to the envelope to be in electrical contact with the sealing layer and serves to energize the sealing layer.

2. An image display device according to claim 1, wherein the electrode member has a first sheet portion and a second sheet portion formed by bending a metal sheet each and opposed to each other across a gap and a conduction portion connecting the first and second sheet portions, and is attached to the envelope with the peripheral edge portion of the front substrate or the rear substrate held between the first and second sheet portions.

3. An image display device according to claim 2, wherein the first sheet portion has a contact portion in electrical contact with the sealing layer.

4. An image display device according to claim 2, wherein the envelope has a frame-shaped sidewall joined between the respective peripheral edge portions of the front substrate and the rear substrate, at least one of the rear and front substrates being sealed to the sidewall with the sealing layer therebetween, and the electrode member is attached to the envelope with the sidewall and the peripheral edge portion of the at least one of the rear and front substrates held between the first and second sheet portions.

5. An image display device according to claim 1, wherein the electrode member has a contact portion in electrical contact with the sealing layer, a body portion extending from the contact portion to the outside of the envelope, and a conduction portion exposed to the outside of the envelope, the body portion having an outflow restraining portion situated higher than the contact portion with respect to the vertical direction.

6. An image display device according to claim 1, wherein the electrode member has a contact portion in electrical contact with the sealing layer and a body portion and a drain portion which extend from the contact portion to the outside of the envelope, the body portion having an outflow restraining portion situated higher than the contact portion with respect to the vertical direction, the drain portion being situated lower than the contact portion with respect to the vertical direction.

7. An image display device according to claim 5, wherein the electrode member has a conduction portion exposed or projecting to the outside of the envelope.

8. An image display device according to claim 5 or 6, wherein the electrode member has an attachment portion nipping the peripheral edge portion of the front substrate or the rear substrate and is attached to the envelope.

9. An image display device according to claim 5, wherein the electrode member is formed by bending a metal sheet.

10. An image display device according to claim 5, wherein the contact portion of the electrode member has a horizontal portion with a horizontal extension length of 2 mm or more.

11. An image display device according to claim 6, wherein the drain portion of the electrode member has a width narrower than the width of the body portion.

12. An image display device according to claim 5, wherein the contact portion of the electrode member and neighboring regions thereof are loaded with an electrically conductive material.

13. An image display device according to claim 6, wherein the contact portion of the electrode member and neighboring regions thereof and the drain portion and neighboring regions thereof are loaded with an electrically conductive material.

14. An image display device according to claim 1, wherein the electrode member has a contact portion in electrical contact with the sealing layer and a body portion extending from the contact portion to the outside of the envelope, at least a part of the body portion having a cross-sectional area smaller than a cross-sectional area of the contact portion.

15. An image display device according to claim 14, wherein the contact portion of the electrode member is situated higher than the body portion with respect to the vertical direction.

16. An image display device according to claim 1, wherein the electrode-member has a plurality of contact portions individually in electrical contact with the sealing layer and arranged across gaps through which the sealing material can flow out.

17. An image display device according to claim 16, wherein the electrode member has a plurality of contact portions individually in contact with the sealing layer on either side of one corner portion of the envelope.

18. An image display device according to claim 16, wherein the electrode member has a plurality of contact portions individually in contact with the sealing layer on one side of one corner portion of the envelope.

19. An image display device according to claim 16, wherein the electrode member is formed in the shape of a Y having two contact portions.

20. An image display device according to claim 1, wherein the sealing layer is formed in the shape of a substantially rectangular frame, and a plurality of said electrode members are arranged symmetrically with respect to the sealing layer and connected electrically to the sealing layer.

21. An image display device according to claim 1, wherein the sealing layer is formed in the shape of a substantially rectangular frame, and the electrode member includes a first electrode attached to the rear substrate and connected electrically to the sealing layer and a second electrode attached to the front substrate and connected electrically to the sealing layer.

22. An image display device according to claim 1, wherein the sealing material contains at least one of elements including In, Sn, Pb, Ga and Bi.

23. An image display device according to claim 1, wherein the electrode member is formed of a simple element or an alloy which contains at least one of elements including Cu, Al, Fe, Ni, Co, Be and Cr.

24. An image display device according to claim 1, which comprises phosphor layers provided on an inner surface of the front substrate and a plurality of electron emitting elements which are provided on an rear substrate and excite the phosphor layers.

25. An image display device according to claim 1, wherein the envelope has a frame-shaped sidewall joined between the respective peripheral edge portions of the front substrate and the rear substrate, and the sealing layer is located between the sidewall and at least one of the front and rear substrates.

26. An image display device comprising:
an envelope including a front substrate and a rear substrate opposed to each other and having respective peripheral edge portions thereof joined together with an electrically conductive sealing material; and
a plurality of electrode members at least parts of which are covered by an electrically conductive material layer and which are connected individually electrically to the sealing material through the electrically conductive material layer.

27. An image display device according to claim 26, wherein the envelope has a frame-shaped sidewall joined between the respective peripheral edge portions of the front substrate and the rear substrate, and the sealing material is located between the sidewall and at least one of the front and rear substrates.

28. An image display device according to claim 26, wherein the sealing material is provided in the form of a frame along a peripheral edge portion of the envelope, and the plurality of electrode members are provided at least two corner portions of the envelope.

29. An image display device according to claim 26, wherein each of the electrode members is formed of a simple element or an alloy which contains at least one of elements including Cu, Al, Fe, Ni, Co, Be and Cr.

30. An image display device according to claim 26, wherein the sealing material contains any of elements including In, Sn, Pb, Ga and Bi.

31. An image display device according to claim 26, wherein the electrically conductive material layer contains at least one of elements including In, Sn, Pb, Ga and Bi.

32. An image display device comprising:
an envelope which has a front substrate and a rear substrate opposed to each other and a sealing layer which is located along a peripheral edge portion of the inner surface of at least one of the front and rear substrates and contains an electrically conductive sealing material, the peripheral portions of the front substrate and the rear substrate being joined together with the sealing layer therebetween; and
a plurality of pixels provided in the envelope,
the sealing layer having a plurality of recesses which individually open outward of the envelope.

33. An image display device according to claim 32, wherein the plurality of recesses are situated individually at two or four corner portions of the envelope.

34. An image display device comprising:
an envelope which has a front substrate and a rear substrate opposed to each other and a sealing layer which is located along a peripheral edge portion of the inner surface of at least one of the front and rear substrates and contains an electrically conductive sealing material, the peripheral portions of the front substrate and the rear substrate being joined together with the sealing layer therebetween; and
a plurality of pixels provided in the envelope,
the envelope having a plurality of conductor pieces each including a contact portion joined to the sealing layer and situated on the peripheral edge portion of the envelope.

35. An image display device according to claim 34, wherein the conductor pieces are located individually on corner portions of the envelope.

36. A method of manufacturing an image display device which is provided with an envelope having a front substrate and a rear substrate opposed to each other and having respective peripheral portions thereof joined together, the method comprising:
locating an electrically conductive sealing material on the peripheral edge portion of at least one of the front and rear substrates, thereby forming a sealing layer;
attaching an electrode member to the at least one of the front and rear substrates having the sealing layer formed thereon, and connecting the electrode member electrically to the sealing layer; and
energizing the sealing layer through the electrode member with the front substrate and the rear substrate opposed to each other, thereby heat-melting the sealing layer to join together the respective peripheral portions of the front substrate and the rear substrate.

37. A method of manufacturing an image display device which is provided with an envelope having a front substrate and a rear substrate opposed to each other and having respective peripheral portions thereof joined together, the method comprising:
locating an electrically conductive sealing material on the respective peripheral edge portions of the front substrate and the rear substrate, thereby forming individual sealing layers;
attaching an electrode member to the at least one of the front and rear substrates, thereby connecting the electrode member electrically to the sealing layer formed on the at least one of the substrates; and
energizing the sealing layers through the electrode member after opposing the front substrate and the rear substrate to each other and bringing the electrode member into electrical contact with the sealing layer formed on the other of the front and rear substrates, thereby heat-melting the sealing layers to join together the respective peripheral portions of the front substrate and the rear substrate.

38. A method of manufacturing an image display device which is provided with an envelope having a front substrate and a rear substrate opposed to each other and having respective peripheral portions thereof joined together, the method comprising:
locating an electrically conductive sealing material on the peripheral edge portion of at least one of the front and rear substrates, thereby forming a sealing layer;
preparing an electrode member provided with a contact portion, a body portion extending from the contact portion and having an outflow restraining portion situated higher than the contact portion with respect to the vertical direction, and a conduction portion;
attaching the electrode member to the at least one of the front and rear substrates having the sealing layer formed thereon with the body portion extending outward from the sealing layer and with the conduction portion exposed or projecting to the outside, thereby bringing the contact portion into electrical contact with the sealing layer; and
energizing the sealing layer through the electrode member with the front substrate and the rear substrate opposed to each other, thereby heat-melting the sealing layer to join together the respective peripheral portions of the front substrate and the rear substrate.

39. A method of manufacturing an image display device which is provided with an envelope having a front substrate and a rear substrate opposed to each other and having respective peripheral portions thereof joined together, the method comprising:
locating an electrically conductive sealing material on the peripheral edge portion of at least one of the front and rear substrates, thereby forming a sealing layer;
preparing an electrode member provided with a contact portion, a body portion extending from the contact portion and having an outflow restraining portion situated higher than the contact portion with respect to the vertical direction, and a drain portion extending from the contact portion and situated lower than the contact portion with respect to the vertical direction;
attaching the electrode member to the at least one of the front and rear substrates having the sealing layer formed thereon with the body portion and the drain portion extending outward from the sealing layer and with the conduction portion exposed or projecting to the outside, thereby bringing the contact portion into electrical contact with the sealing layer; and
energizing the sealing layer through the electrode member with the front substrate and the rear substrate opposed to each other, thereby heat-melting the sealing layer, pressurizing the front substrate and the rear substrate in a direction such that the substrates approach each other, thereby joining together the respective peripheral portions of the front substrate and the rear substrate with the melted sealing material, and causing a surplus of the melted sealing material to flow out through the drain portion of the electrode member.

40. A method of manufacturing an image display device which is provided with an envelope having a front substrate and a rear substrate opposed to each other and having respective peripheral portions thereof joined together, the method comprising:
locating an electrically conductive sealing material between the respective peripheral edge portions of the front substrate and the rear substrate, thereby forming a sealing layer;
preparing an electrode member having a plurality of contact portions arranged across gaps through which the sealing material can flow out;
bringing the plurality of contact portions of the electrode member individually into electrical contact with the sealing layer; and
energizing the sealing layer through the electrode member with the front substrate and the rear substrate pressurized in a direction such that the substrates approach each other, thereby heat-melting the sealing layer, joining together the respective peripheral portions of the front substrate and the rear substrate with the melted sealing material, and causing a surplus of the melted sealing material to flow out through the gaps between the contact portions of the electrode member.

41. A method manufacturing an image display device which is provided with an envelope having a front substrate and a rear substrate opposed to each other and having respective peripheral portions thereof joined together, the method comprising:
locating an electrically conductive sealing material between the respective peripheral edge portions of the front substrate and the rear substrate, thereby forming a sealing layer;
preparing a plurality of electrode members at least parts of which are covered by an electrically conductive material layer;
bringing the electrode members individually into electrical contact with the sealing layer with the electrically conductive material layer therebetween; and
energizing the sealing layer through the electrode members to fuse the sealing material and joining together the respective peripheral portions of the front substrate and the rear substrate.

42. A method manufacturing an image display device according to claim 41, wherein the electrically conductive material layer is formed by supplying the electrically conductive material to the electrode members while applying ultrasonic waves thereto.

43. A method of manufacturing an image display device according to claim 36, wherein a frame-shaped sidewall is located between the respective peripheral edge portions of the front substrate and the rear substrate, the sealing layer is provided between the sidewall and at least one of the front and rear substrates, and the sealing material is fused by energizing the sealing layer with the electrode members.

44. A method of manufacturing an image display device according to claim 36, wherein the sealing material is a metal containing at least one of elements including In, Sn, Pb, Ga and Bi.

45. A method of manufacturing an image display device according to claim 36, wherein the temperature of the front substrate and the rear substrate is set to be lower than the melting point of the sealing material.

46. A method of manufacturing an image display device according to claim 36, wherein the envelope is kept in a vacuum atmosphere as the sealing layer is energized.

47. A method of manufacturing an image display device according to claim 36, wherein the front substrate and the rear substrate are cooled to a temperature lower than the melting point of the sealing material with a vacuum atmosphere maintained after the substrates are heated to be degassed in the vacuum atmosphere, heat-melting only the sealing material by energizing the sealing layer, and the sealing layer is cooled to be solidified by stopping current supply to the sealing layer and transmitting heat from the sealing layer to the front substrate and the rear substrate.

48. A method of manufacturing an image display device which is provided with an envelope having a front substrate and a rear substrate opposed to each other and having respective peripheral portions thereof joined together and a plurality of pixels provided in the envelope, the method comprising:
locating an electrically conductive sealing material on the peripheral portion of at least one of the front and rear substrates, thereby forming a sealing layer;
opposing the front substrate and the rear substrate to each other with the sealing material therebetween;
pressurizing at least one of the opposed front and rear substrates in a direction such that the front substrate and the rear substrate approach each other, thereby holding at least a part of the sealing material in contact between the respective peripheral portions of the front substrate and the rear substrate; and
energizing the sealing layer in the pressurized state by an electrode member, thereby heat-melting the sealing material.

49. A method of manufacturing an image display device according to claim 48, wherein sealing layers are formed by locating electrically conductive sealing materials individually on the peripheral portion of the front substrate and the peripheral portion of the rear substrate, and the sealing layers are energized in a manner such that the sealing layers are at least partially in contact with each other.

50. A method of manufacturing an image display device which is provided with an envelope having a front substrate and a rear substrate opposed to each other and having respective peripheral portions thereof joined together with a sidewall therebetween and a plurality of pixels provided in the envelope, the method comprising:
locating an electrically conductive sealing material on the sidewall and/or the peripheral portion of at least one of the front and rear substrates;
opposing the front substrate and the rear substrate to each other with the sealing material and the sidewall therebetween;
pressurizing at least one of the opposed front and rear substrates in a direction such that the front substrate and the rear substrate approach each other, thereby holding at least a part of the sealing material in contact between the sidewall and the peripheral portion of the at least one of the front and rear substrates; and
energizing the sealing layer in the pressurized state by an electrode member, thereby heat-melting the sealing material.

51. A method of manufacturing an image display device according to claim 50, wherein sealing layers are formed by locating electrically conductive sealing materials individually on the sidewall and the peripheral portion of at least one of the front and rear substrates, and the sealing layers are energized in a manner such that the sealing layers are at least partially in contact with each other.

52. A method of manufacturing an image display device according to claim 48, wherein the electrode member is sandwiched between the sealing layers and the sealing material is energized through the electrode member.

53. A method of manufacturing an image display device which is provided with an envelope having a front substrate and a rear substrate opposed to each other and having respective peripheral portions thereof joined together and a plurality of pixels provided in the envelope, the method comprising:
locating an electrically conductive sealing material individually on the respective peripheral portions of the front and rear substrates, thereby forming sealing layers;
opposing the front substrate and the rear substrate to each other with the sealing layers therebetween;
welding together at least parts of the sealing layers provided between the opposed front and rear substrates; and
bringing an electrode member into contact with the welded portions and energizing both the sealing layers through the electrode member, thereby heat-melting the sealing material.

54. A method of manufacturing an image display device which is provided with an envelope having a front substrate and a rear substrate opposed to each other and having respective peripheral portions thereof joined together, the method comprising:
locating an electrically conductive sealing material on the peripheral edge portion of at least one of the front and rear substrates, thereby forming a sealing layer;
preparing an electrode member which is provided with an attachment portion attachable to at least one of the front and rear substrates and a contact portion capable of touching the sealing layer;
attaching the electrode to the at least one of the front and rear substrates with a gap kept between the contact portion and the sealing layer;
opposing the front substrate and the rear substrate to each other without varying the gap between the contact portion and the sealing layer;
pressurizing the opposed front and rear substrates in a direction such that the substrates approach each other, thereby bringing the front substrate and the rear substrate into contact with each other with the sealing layer therebetween and bringing the contact portion of the electrode member into electrical contact with the sealing layer; and
energizing the sealing layer in the pressurized state through the electrode member, thereby heat-melting the sealing layer and joining together the respective peripheral portions of the front substrate and the rear substrate.

55. A method of manufacturing an image display device which is provided with an envelope having a front substrate and a rear substrate opposed to each other and having respective peripheral portions thereof joined together, the method comprising:
locating an electrically conductive sealing material on the peripheral edge portion of at least one of the front and rear substrates, thereby forming a sealing layer;
preparing an electrode member which is provided with an attachment portion attachable to at least one of the front and rear substrates and a contact portion capable of touching the sealing layer;
attaching the electrode member to the front substrate and the rear substrate with a gap kept between the contact portion and the sealing layer;
opposing the front substrate and the rear substrate to each other without varying the gap between the contact portion and the sealing layer;
moving the opposed front and rear substrates in a direction such that the substrates approach each other, thereby bringing the contact portion of the electrode member attached to the front substrate into electrical contact with the sealing layer of the rear substrate and bringing the contact portion of the electrode member attached to the rear substrate into electrical contact with the sealing layer of the front substrate;
energizing the sealing layer through the electrode member with the electrode member in electrical contact with the sealing layer, thereby heat-melting the sealing layer, and pressurizing the opposed front and rear substrates in the mutually approaching direction, thereby joining together the respective peripheral portions of the front substrate and the rear substrate.

56. A method of manufacturing an image display device which is provided with an envelope having a front substrate and a rear substrate opposed to each other and having respective peripheral portions thereof joined together, the method comprising:
locating an electrically conductive sealing material on the peripheral edge portion of at least one of the front and rear substrates, thereby forming a sealing layer;
preparing an electrode member which is provided with an attachment portion attachable to at least one of the front and rear substrates and a contact portion capable of touching the sealing layer;
attaching the electrode member to the front substrate or the rear substrate with a gap kept between the contact portion and the sealing layer;
opposing the front substrate and the rear substrate to each other without varying the gap between the contact portion and the sealing layer;
moving the opposed front and rear substrates in a direction such that the substrates approach each other;
bringing the contact portion of the electrode member into electrical contact with the sealing layer; and
energizing the sealing layer through the electrode member with the electrode member in electrical contact with the sealing layer, thereby heat-melting the sealing layer, and pressurizing the opposed front and rear substrates in the mutually approaching direction, thereby joining together the respective peripheral portions of the front substrate and the rear substrate.

57. A method of manufacturing an image display device according to claim 54, wherein the opposed front and rear substrates are pressurized in the mutually approaching direction after the front substrate and the rear substrate are heated so that an adsorbed gas is released from the front substrate and the rear substrate.

58. A method of manufacturing an image display device according to claim 54, wherein the opposed front and rear substrates are pressurized in the mutually approaching direction after at least one of the front and rear substrates is irradiated with electron beams to be subjected to electron beam cleaning.

59. A method of manufacturing an image display device according to claim 57, wherein the opposed front and rear substrates are pressurized in the mutually approaching direction after a getter film is formed on the inner surface of the front substrate after the adsorbed gas is released.

60. A method of manufacturing an image display device according to claim 54, wherein the contact portion of the electrode member is previously coated with In or an alloy containing In.

61. A method of manufacturing an image display device according to claim 54, wherein the attachment of the electrode member has a clip-shaped nipping portion capable of nipping the peripheral edge portion of at least one of the front and rear substrates.

62. A method of manufacturing an image display device according to claim 54, wherein the electrode member has a body portion extending from the attachment portion and a conduction portion, and the contact portion extends from the body portion.

63. A method of manufacturing an image display device according to claim 48, wherein the sealing material is a metal containing In, Sn, Pb, Ga or Bi.

64. A method of manufacturing an image display device according to claim 48, wherein the sealing layer is electrically heated in a vacuum atmosphere.

65. A method of manufacturing an image display device which is provided with an envelope having a front substrate and a rear substrate opposed to each other and having respective peripheral portions thereof joined together with a sealing layer therebetween and a plurality of pixels provided in the envelope, the method comprising:
locating an electrically conductive sealing material along a peripheral edge portion of the inner surface of at least one of the front and rear substrates, thereby forming a sealing layer;
energizing the sealing layer through the electrode member in electrical contact with the sealing layer with the front substrate and the rear substrate opposed to each other, thereby heat-melting the sealing layer and joining together the respective peripheral portions of the front substrate and the rear substrate with the melted sealing material; and
removing the electrode member after the joining.

66. A method of manufacturing an image display device according to claim 65, wherein the electrode member is removed by cutting an interface between the electrode member and the sealing layer by ultrasonic cutting.

67. A method of manufacturing an image display device according to claim 66, wherein the electrode member is removed by applying ultrasonic waves to the electrode member to subject the interface between the electrode member and the sealing layer to ultrasonic cutting.

68. A method of manufacturing an image display device according to claim 65, wherein the electrode member is removed with the sealing layer heated to be softened or melted at a peripheral portion of the electrode member after the front substrate and the rear substrate are joined together.

69. A method of manufacturing an image display device which is provided with an envelope having a front substrate and a rear substrate opposed to each other and having respective peripheral portions thereof joined together and a plurality of pixels provided in the envelope, the method comprising:
locating an electrically conductive sealing material along a peripheral edge portion of the inner surface of at least one of the front and rear substrates, thereby forming a sealing layer;
bringing the contact portion of the electrode member into electrical contact with the sealing layer;
energizing the sealing layer through the electrode member with the front substrate and the rear substrate opposed to each other, thereby heat-melting the sealing layer and joining together the respective peripheral portions of the front substrate and the rear substrate with the melted sealing material; and
cutting that part of the electrode member near the contact portion in contact with the sealing layer, thereby removing other parts of the electrode member than the part near the contact portion.

70. A method of manufacturing an image display device according to claim 69, wherein the electrode member is provided with an attachment portion attached to at least one of the front and rear substrates and a body portion extending from the attachment portion to the contact portion, and the body portion and the attachment portion are removed from the envelope by cutting that part of the body portion near the contact portion after the joining.

71. A method of manufacturing an image display device which is provided with an envelope having a front substrate and a rear substrate opposed to each other and having respective peripheral portions thereof joined together and a plurality of pixels provided in the envelope, the method comprising:
locating an electrically conductive sealing material along a peripheral edge portion of the inner surface of at least one of the front and rear substrates;
energizing the sealing material through the electrode member in electrical contact with the sealing material with the front substrate and the rear substrate opposed to each other, thereby heat-melting the sealing material;
removing and separating the electrode member from the sealing material with the sealing material melted after the energization is finished; and
joining together the respective peripheral portions of the front substrate and the rear substrate with the melted sealing material.

72. A method of manufacturing an image display device according to claim 71, wherein the electrode member is brought into contact with the sealing material immediately before the energization and is removed and separated from the sealing material after the energization is finished.

73. A method of manufacturing an image display device which is provided with an envelope having a front substrate and a rear substrate opposed to each other and having respective peripheral portions thereof joined together and a plurality of pixels provided in the envelope, the method comprising:
locating an electrically conductive frame-shaped member and a heat-meltable sealing material along a peripheral edge portion of the inner surface of at least one of the front and rear substrates;
energizing the frame-shaped member through the electrode member in electrical contact with the frame-shaped member with the front substrate and the rear substrate opposed to each other, thereby heating the frame-shaped member to melt the sealing material;
removing and separating the electrode member from the frame-shaped member with the sealing material melted after the energization is finished; and
joining together the respective peripheral portions of the front substrate and the rear substrate with the melted sealing material.

74. A method of manufacturing an image display device according to claim 73, wherein the electrode member is brought into contact with the frame-shaped member immediately before the energization and is removed and separated from the frame-shaped member after the energization is finished.

75. A method of manufacturing an image display device according to claim 71, wherein the sealing material is a metal containing at least one of elements including In, Sn, Pb, Ga and Bi.

76. A manufacturing apparatus for an image display device which is provided with an envelope having a front substrate and a rear substrate opposed to each other and having respective peripheral portions thereof joined together, a sealing layer containing an electrically conductive material located along a peripheral edge portion of the inner surface of at least one of the front and rear substrates, and a plurality of pixels provided in the envelope, the manufacturing apparatus comprising:
an electrode member capable of coming into electrical contact with the sealing layer;
a power source which supplies current through the electrode member;
a holder which holds and fixes the electrode member; and
a drive mechanism which moves the holder in the in-plane direction of the front substrate or the rear substrate.

77. A manufacturing apparatus for an image display device which is provided with an envelope having a front substrate and a rear substrate opposed to each other and having respective peripheral portions thereof joined together, a sealing layer containing an electrically conductive material located along a peripheral edge portion of the inner surface of at least one of the front and rear substrates, and a plurality of pixels provided in the envelope, the manufacturing apparatus comprising:
a plurality of electrode members arranged for electrical contact with the sealing layer;
a power source which supplies current to the sealing layer through the electrode members; and
a drive mechanism which drives the electrode members in the in-plane direction of at least one of the front and rear substrates.
